(19) United States
(12) Patent Application Publication
(10) Pub. No.: US 2022/0227302 A1
(43) Pub. Date: Jul. 21, 2022

(54) COMPONENT FOR VEHICLE INTERIOR

(71) Applicant: Shanghia Yanfeng Jinqiao Automotive Trim Systems Co, Ltd., Novi, MI (US)

(72) Inventors: Jixiang Zhang, Shanghai (CN); Yanhua Ma, Shanghai (CN); Meisui Lin, Shanghai (CN); Zhen Yang, Novi, MI (US)

(21) Appl. No.: 17/716,421

(22) Filed: Apr. 8, 2022

Related U.S. Application Data
(63) Continuation-in-part of application No. PCT/CN2020/120211, filed on Oct. 10, 2020.

(30) Foreign Application Priority Data
Oct. 10, 2019 (CN) 201910959785.8

(51) Int. Cl. B60R 7/04

(52) U.S. Cl. CPC B60R 7/04; B60R 2011/0007

(57) ABSTRACT

A component for a vehicle interior configured to be operated by an operator control is disclosed. The component may comprise a cover movable relative to a base between a closed position and an open position, a spring-actuated mechanism for the cover and a motor-actuated mechanism for the cover. The cover may be moved in a tension/spring-actuated mode under actuation of the spring-actuated mechanism and/or a motor-actuated mode under actuation by the motor-actuated mechanism. The cover may move on a track system comprising a gear track. The motor-actuated mechanism may comprise a cable-drive system. The spring-actuated mechanism may use spring/tension action to open the cover. The component may comprise a receptacle movable between a retracted position and an extended position. The component may comprise a latch mechanism for the cover actuated by an operator control and/or movement of the receptacle. The component may provide a manually-operated mode.

### CROSS-REFERENCE TO RELATED APPLICATIONS

The present application is a continuation in part of PCT/International Patent Application No. PCT/CN2020/120211 filed Oct. 10, 2020, which claims the benefit of Chinese Patent Application No. 201910959785.8 filed Oct. 10, 2019 (now Chinese Patent No. 110525354B).

The present application claims priority to and incorporates by reference in full the following patent applications: (a) Chinese Patent Application No. 201910959785.8 filed Oct. 10, 2019 (now Chinese Patent No. 110525354B); (b) PCT/International Patent Application No. PCT/CN2020/120211 filed Oct. 10, 2020.

### FIELD

The present invention relates to a component for a vehicle interior.

The present invention also relates to component for a vehicle interior providing a base with a compartment and a cover movable relative to the base.

### BACKGROUND

It is known to provide a component for a vehicle interior providing a base with a compartment and a cover movable relative to the base.

It would be advantageous to provide an improved component for a vehicle interior providing a base with a compartment and a cover movable relative to the base.

It would be advantageous to provide an improved component for a vehicle interior providing a base with a compartment and a cover movable relative to the base with a tension/spring-actuated mode and a motor-actuated mode.

### SUMMARY

The present invention relates to a component for a vehicle interior configured to be operated by an operator control comprising a base comprising a compartment, a cover configured to be movable relative to the base between a closed position and an open position, a spring-actuated mechanism configured to move the cover; a motor-actuated mechanism configured to move the cover. The cover may be configured to be moved in at least one of (a) a spring-actuated mode under actuation of the spring-actuated mechanism and/or (b) a motor-actuated mode under actuation by the motor-actuated mechanism. The component may comprise a motor configured to actuate the motor-actuated mechanism. The cover may be configured to move on a track system; the track system may comprise a gear track. The motor-actuated mechanism may comprise a cable-drive system. The spring-actuated mechanism may be configured to use spring action to move the cover from the closed position to the open position. The operator control may be configured to operate the motor-actuated mechanism. The operator control may be configured to operate the spring-actuated mechanism. The component may comprise a latch mechanism configured to retain the cover in the closed position relative to the base. The latch mechanism may comprise a spring-operated mechanism. The operator control may be configured to operate the latch mechanism. The operator control may comprise a button mechanism configured to release the latch mechanism and to move the cover in the spring-actuated mode. The cover may be configured to move in the spring-actuated mode from the closed position to the open position and in the motor-actuated mode from the open position to the closed position. The component may comprise a receptacle configured to be movable relative to the base between a retracted position within the base and an extended position. The component may comprise a mechanism configured to be actuated by movement of the receptacle from the retracted position toward the extended position. The mechanism may be configured to release a latch mechanism for movement of the cover toward the open position when the receptacle is moved toward the extended position. The mechanism may comprise a switch actuated by movement of the receptacle. The receptacle may be movable relative to the base on a track system.

The present invention relates to a component for a vehicle interior comprising a base comprising a compartment, a cover configured to be movable relative to the base between a closed position and an open position, a motor-actuated mechanism configured to move the cover; an operator control configured to operate movement of the cover. The cover may be configured to be moved in at least one of (a) a tension-actuated mode and/or (b) a motor-actuated mode under actuation by the motor-actuated mechanism. The operator control may comprise a button mechanism configured to release a latch mechanism and for movement of the cover in the tension-actuated mode; the latch mechanism may comprise a spring-operated mechanism configured to retain the cover in the closed position and to release the cover for movement toward the open position. The operator control may be configured to initiate movement of the cover in the motor-actuated mode. The component may comprise a tension-actuated mechanism configured to use spring force to move the cover from the open position to the closed position in the tension-actuated mode; the motor-actuated mechanism may comprise a cable-drive system operated by a motor to move the cover from the open position to the closed position in the motor-actuated mode. The operator control may comprise a button configured to initiate movement of the cover in the tension-actuated mode. The cover may be configured to be moved from the open position to the closed position in a manually-actuated mode.

The present invention relates to a component for a vehicle interior comprising a base comprising a compartment, a cover configured to be movable relative to the base between a closed position and an open position, a spring-actuated mechanism configured to move the cover, a motor-actuated mechanism configured to move the cover; an operator control configured to operate movement of the cover. The cover may be configured to be moved in at least one of (a) spring-actuated mode under actuation of the spring-actuated mechanism and/or (b) a motor-actuated mode under actuation by the motor-actuated mechanism. The operator control may be configured to initiate movement of the cover in the motor-actuated mode.

The present invention relates to a vehicle interior trim/component comprising a base having a storage compartment and a cover. The cover may be configured to be movable relative to the base between a first closed position where the storage compartment is covered and a first open position where the storage compartment is exposed in both an electric mode and a manual mode. The interior trim may comprise a slide driven by a motor and moving relative to the base between the first closed position and the first open position. The cover may be configured to move in the electric mode when the cover is connected with the slide; the cover may be configured to move in the manual mode when the cover is disconnected from the slide. The interior trim may comprise a clutch lock for operating the connection and disconnection of the cover with the slide. The cover may be provided with a switch; the clutch lock may be configured to realize the connection or disconnection of the cover with the slide in response to pressure applied to the switch. The slide may comprise a locking slot; the cover may comprise an unlocking slot. The cover may be connected with the slide when a locking head of the clutch lock is positioned in the locking slot; the cover may be disconnected from the slide when the locking head of the clutch lock is positioned in the unlocking slot. The clutch lock may be disposed on the cover and rotated relative to the cover such that the clutch lock moves from the locking slot into the unlocking slot or from the unlocking slot into the locking slot. The clutch lock may be connected with the cover by a first tension spring that may act on the clutch lock to retain the locking head of the clutch lock in the locking slot. The locking slot may be aligned with the unlocking slot when the cover and the slide are in a same position. The interior trim may comprise a cover lock. The cover may be connected with the cover lock when the slide moves away from the first closed position such that the cover is secured in the first closed position. The cover lock may be configured to rotate in response to the pressure applied to the switch when the cover is connected with the cover lock such that the cover lock is disconnected from the cover. The cover lock may be configured to connect with the cover when the slide is in the first closed position. The cover lock may be connected with the base by a second tension spring. The base may be provided with a stop rod; the stop rod may be configured to define a position of the cover lock under the action of the second tension spring when the slide moves away from the cover lock. Both ends of the slide may be connected with a cable wrapping around a winder. The winder may be connected with the motor to move the slide. The interior trim may comprise a movable storage box connected with the motor. Movement of the storage box may rotate the winder and thereby move the slide.

The present invention relates to a vehicle interior trim/component comprising a base having a storage compartment, a cover and a movable storage box. The cover may be configured to be movable relative to the base between a first closed position where the storage compartment is covered and a first open position where the storage compartment is exposed in both an electric mode and a manual mode. The movable storage box may be configured to move between a second closed position within the base and a second open position where the movable storage box protrudes from the base. The movable storage box may be powered by a motor. The cover may be secured to the base by a cover lock when the cover is in the first closed position. The cover may be released from the base when the movable storage box moves to the second open position. The movable storage box may comprise a push rod. The push rod may contact and push the cover lock to rotate when the movable storage box moves toward the second open position. The interior trim may comprise a clutch lock provided on the cover. Rotation of the clutch lock may rotate the cover lock when the cover is in the first closed position to release the cover from the base. The cover may be provided with a switch. The clutch lock may be configured to rotate in response to pressure applied to the switch to release the cover from the base. The cover may move from the first closed position toward the first open position in response to movement of the movable storage box from the second closed position toward the second open position. The cover may move from the first open position toward the first closed position in response to movement of the movable storage box from the second open position toward the second closed position. The cover may be movable between the first closed position and a first open position when the movable storage box is in any position between the second closed position and the second open position. The cover may remain in the first open position when the movable storage box moves from the second open position toward the second closed position.

The present invention relates to a vehicle interior component comprising a base configured to provide a storage compartment, a cover configured to move relative to the base between a first closed position where the storage compartment is covered and a first open position where an access to the storage compartment is provided; a mechanism configured to drive the cover to move between the first closed position and the first open position. The cover may be configured for an engaged state in which the cover is engaged with the mechanism and a disengaged state in which the cover is disengaged from the mechanism. The mechanism may comprise a motor configured to move the cover between the first closed position and the first open position when the cover is in the engaged state. The vehicle interior component may comprise a connector configured to connect the cover to the mechanism to provide the engaged state. The connector may comprise a slide. The mechanism may be configured to move the connector to move the cover between the first closed position and the first open position. The vehicle interior component may comprise an electrical cable configured to connect the connector with the mechanism. The vehicle interior component may comprise a clutch lock configured to disconnect the cover from the mechanism to provide the disengaged state. The cover may be configured to move between the first closed position and the first open position in response to an external force applied to the cover when the cover is in the disengaged state. The external force may comprise at least one of a force applied to the cover by a hand and a force applied to the cover by a torsion spring. The vehicle interior component may comprise a storage box configured to move relative to the base between a second closed position where the storage box is stored and a second open position where an access to the storage box is provided. The cover may be configured to move from the first closed position toward the first open position when the storage box moves from the second closed position toward the second open position. The cover may be configured to move from the first open position toward the first closed position when the storage box moves from the second open position toward the second closed position. The cover may be configured to move from the first closed position toward the first open position or from the first open position toward the first closed position when the storage box is in the second closed position.

### FIGURES

FIG. 1A is a schematic perspective view of a vehicle according to an exemplary embodiment.

FIG. 1B is a schematic partial perspective view of a vehicle interior according to an exemplary embodiment.

FIG. 2 is a schematic perspective view of a component for a vehicle interior according to an exemplary embodiment.

FIGS. 2A through 2E are schematic perspective views of a component for a vehicle interior according to an exemplary embodiment.

FIGS. 3A through 3F are schematic perspective views of a component for a vehicle interior according to an exemplary embodiment.

FIGS. 4A through 4J are schematic perspective views of a component for a vehicle interior according to an exemplary embodiment.

FIGS. 5A through 5I are schematic perspective views of a component for a vehicle interior according to an exemplary embodiment.

FIGS. 6A and 6B are schematic partial perspective views of a component for a vehicle interior according to an exemplary embodiment.

FIG. 7 is a schematic perspective view of a subassembly of a component for a vehicle interior according to an exemplary embodiment.

FIG. 8 is a schematic perspective view of a subassembly of a component for a vehicle interior according to an exemplary embodiment.

FIG. 9 is a schematic perspective view of a subassembly of a component for a vehicle interior according to an exemplary embodiment.

FIG. 10 is a schematic perspective view of a subassembly of a component for a vehicle interior according to an exemplary embodiment.

FIG. 11 is a schematic perspective view of a subassembly of a component for a vehicle interior according to an exemplary embodiment.

FIGS. 12A and 12B are schematic partial section views of a component for a vehicle interior according to an exemplary embodiment.

FIGS. 13A through 13E are schematic partial section views of a component for a vehicle interior according to an exemplary embodiment.

FIGS. 14A through 14E are schematic partial section views of a component for a vehicle interior according to an exemplary embodiment.

FIGS. 15A through 15H are schematic partial section views of a component for a vehicle interior according to an exemplary embodiment.

FIGS. 16A through 16E are schematic partial section views of a component for a vehicle interior according to an exemplary embodiment.

FIGS. 17A through 17E are schematic partial section views of a component for a vehicle interior according to an exemplary embodiment.

FIGS. 18A through 18E are schematic partial section views of a component for a vehicle interior according to an exemplary embodiment.

FIGS. 19A through 19C are schematic partial section views of a component for a vehicle interior according to an exemplary embodiment.

FIGS. 20A and 20B are schematic partial section views of a component for a vehicle interior according to an exemplary embodiment.

FIGS. 21A and 21B are schematic partial section views of a component for a vehicle interior according to an exemplary embodiment.

FIGS. 22A through 22E are schematic perspective views of a component for a vehicle interior according to an exemplary embodiment.

FIGS. 23A through 23G are schematic perspective views of a component for a vehicle interior according to an exemplary embodiment.

FIGS. 24A and 24B are schematic partial perspective views of a component for a vehicle interior according to an exemplary embodiment.

FIGS. 25A through 25E are schematic section views of a component for a vehicle interior according to an exemplary embodiment.

FIGS. 26A through 26H are schematic perspective views of a component for a vehicle interior according to an exemplary embodiment.

FIGS. 27A and 27B are schematic partial perspective views of a component for a vehicle interior according to an exemplary embodiment.

FIGS. 28A through 28D are schematic section views of a component for a vehicle interior according to an exemplary embodiment.

FIGS. 29A through 29D are schematic section views of a component for a vehicle interior according to an exemplary embodiment.

FIGS. 30A through 30F are schematic section views of a component for a vehicle interior according to an exemplary embodiment.

### DESCRIPTION

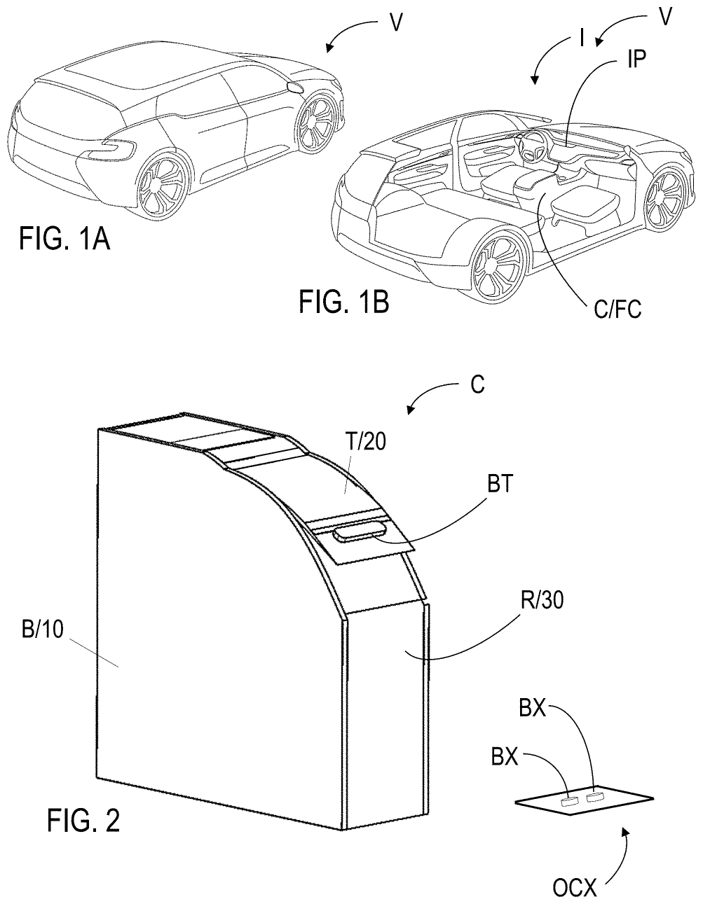

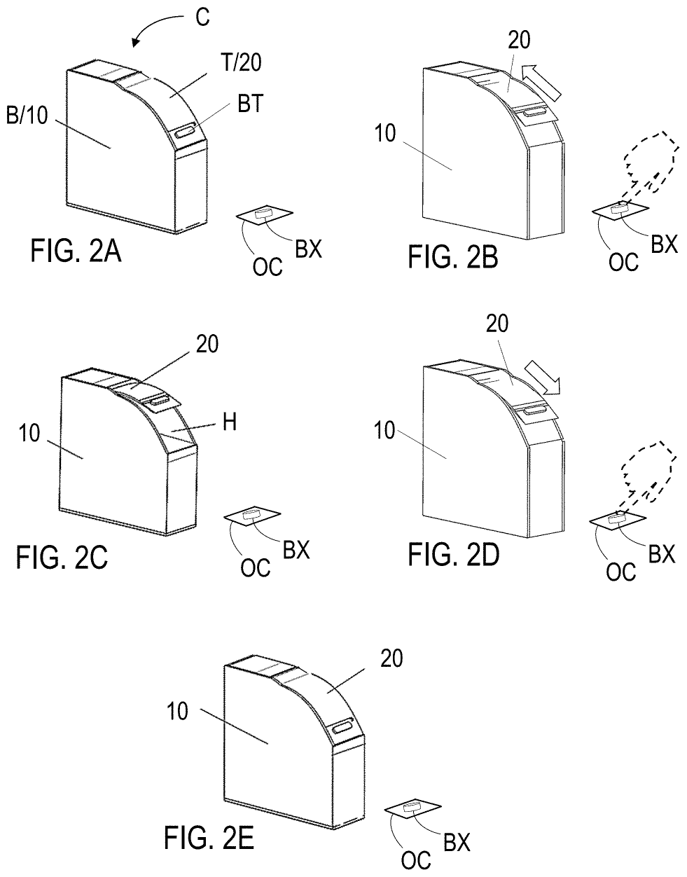

Referring to FIGS. 1A-1B and 2, a vehicle V is shown with an interior I comprising components C such as a floor console FC and instrument panel IP.

According to an exemplary embodiment as shown schematically in FIG. 2, a component for a vehicle interior configured to be operated by an operator control OC may comprise a base B comprising a compartment, a cover T configured to be movable relative to base B between a closed position and an open position, a spring-actuated mechanism TM configured to move cover T, and a motor-actuated mechanism MM configured to move cover T. See also FIGS. 2A-2E, 3A-3F, 4A-4J, 5A-5I, 6A-6B, 12A-12B, 21A-21B, 22A-22E, 23A-23G, 24A-24B and 27A-27B.

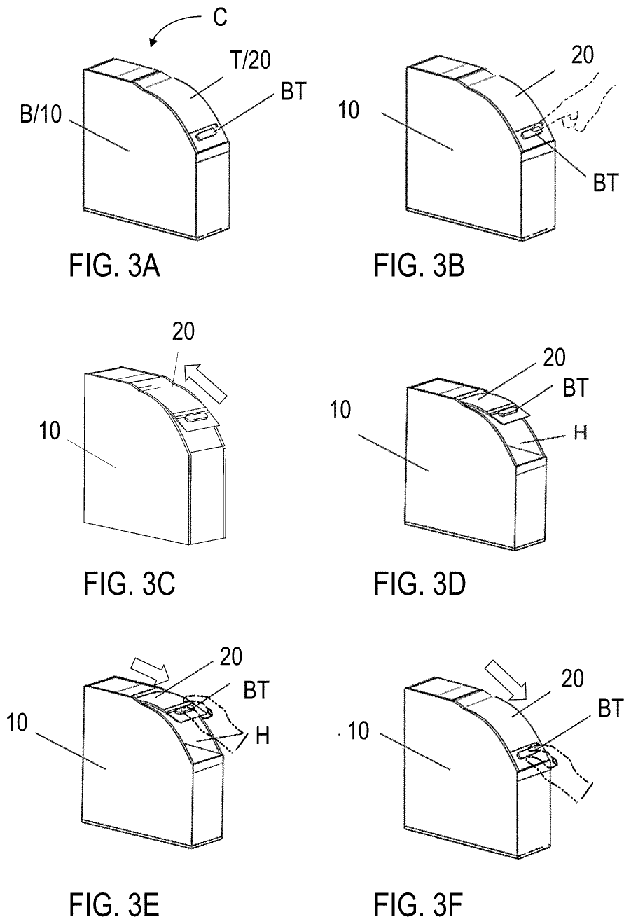

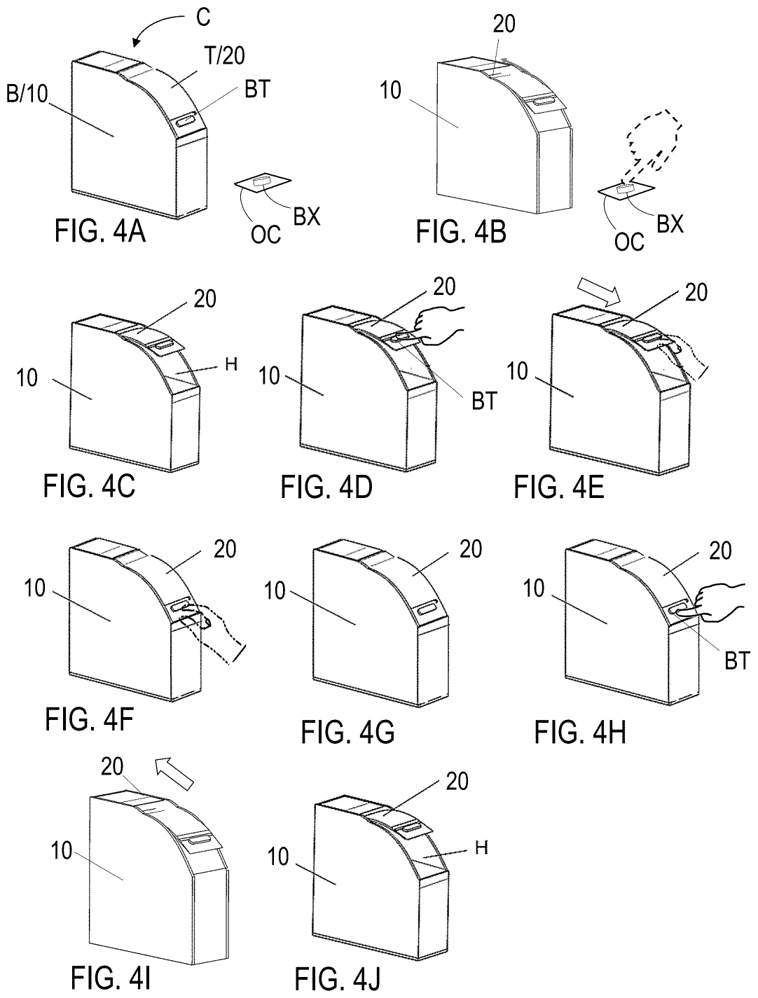

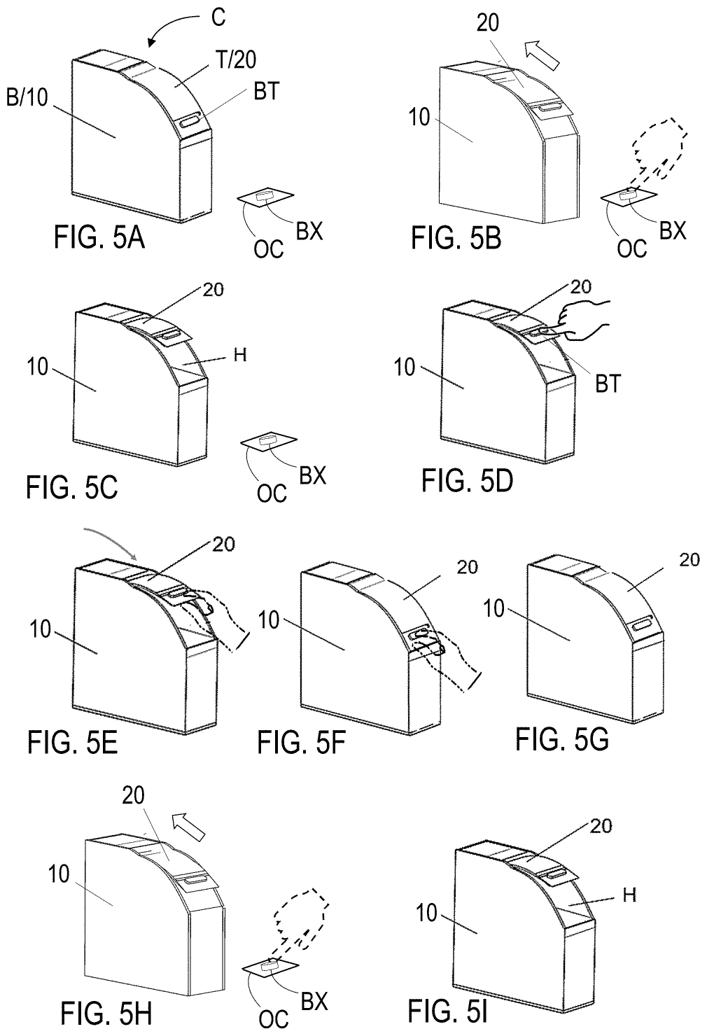

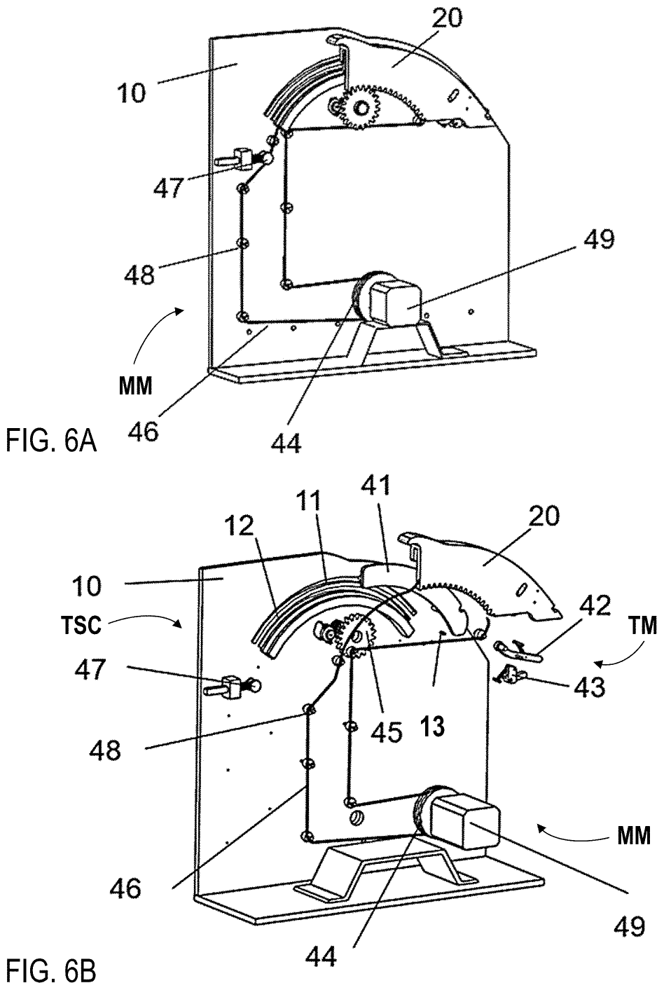

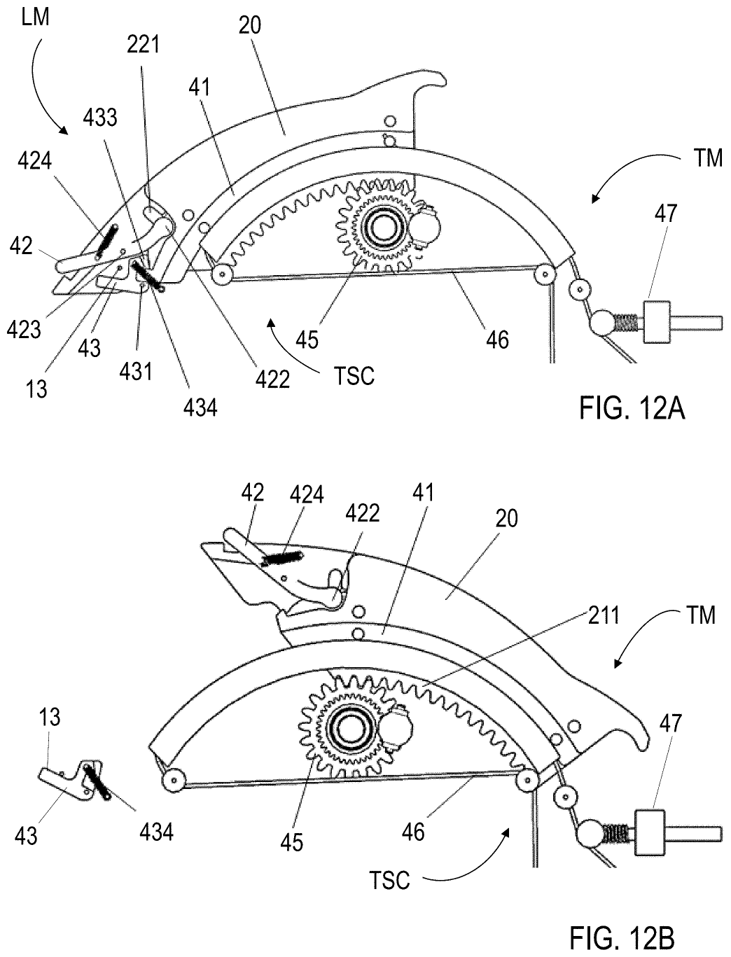

As shown schematically in FIGS. 2A-2E and 3A-3D, cover T may be configured to be moved in at least one of a spring-actuated mode under actuation of spring-actuated mechanism TM and/or a motor-actuated mode under actuation by motor-actuated mechanism MM. See also FIGS. 4A-4J and 5A-5I. As shown schematically in FIGS. 6A-6B, the component may comprise a motor configured to actuate motor-actuated mechanism MM. As shown schematically in FIGS. 6A-6B and 12A-12B, cover T may be configured to move on a track system TSC; track system TSC may comprise a gear track. As shown schematically in FIGS. 6A-6B, motor-actuated mechanism MM may comprise a cable-drive system. As indicated schematically in FIGS. 3A-3D and 12A-12B, spring-actuated mechanism TM may be configured to use spring action to move cover T from the closed position to the open position.

As shown schematically in FIGS. 2 and 2A-2E, operator control OCX may be configured to operate motor-actuated mechanism MM. See also FIGS. 6A-6B. As shown schematically in FIGS. 2 and 3A-3D, operator control OC may be configured to operate spring-actuated mechanism TM. See also FIGS. 12A-12B. As shown schematically in FIGS. 12A-12B, the component may comprise a latch mechanism LM configured to retain cover T in the closed position relative to base B; latch mechanism LM may comprise a spring-operated mechanism; operator control OC may be configured to operate latch mechanism LM. See FIGS. 3A-3D, 13A-13E, 14A-14E and 15A-15D. As shown schematically in FIGS. 2 and 3A-3D, operator control OC may comprise a button mechanism BT configured to release latch mechanism LM and to move cover T in the spring-actuated mode.

As shown schematically in FIGS. 2A-2E, 3A-3D, 4A-4C, 5A-5C, 5H-5I, 13A-13E, 14A-14E and 15A-15D, cover T may be configured to move in the spring-actuated mode from the closed position to the open position and in the motor-actuated mode from the open position to the closed position.

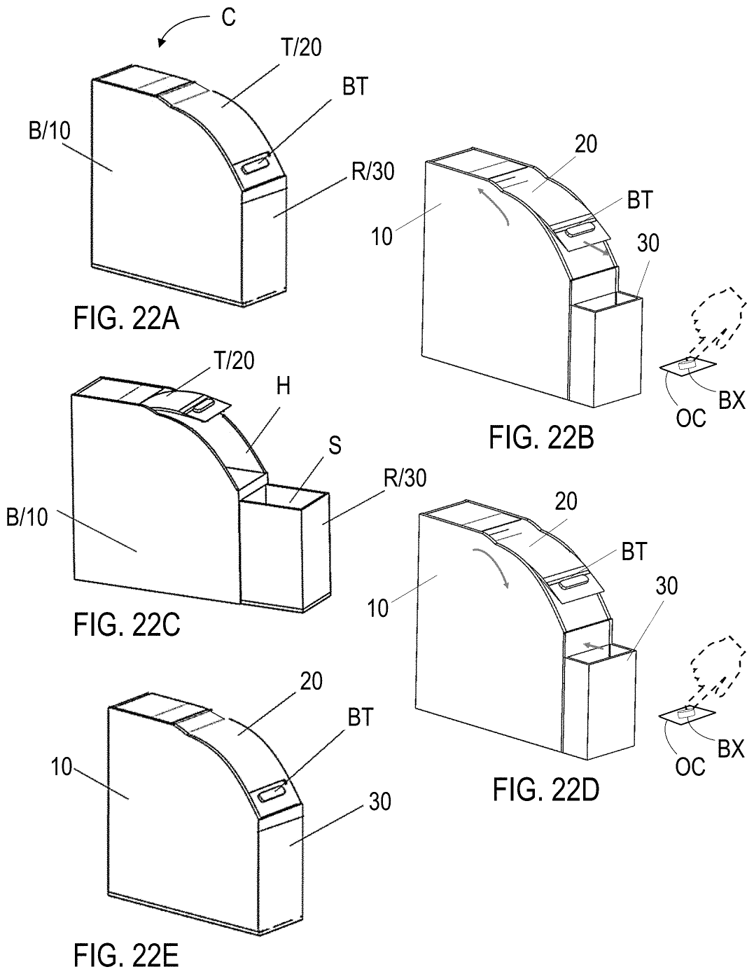

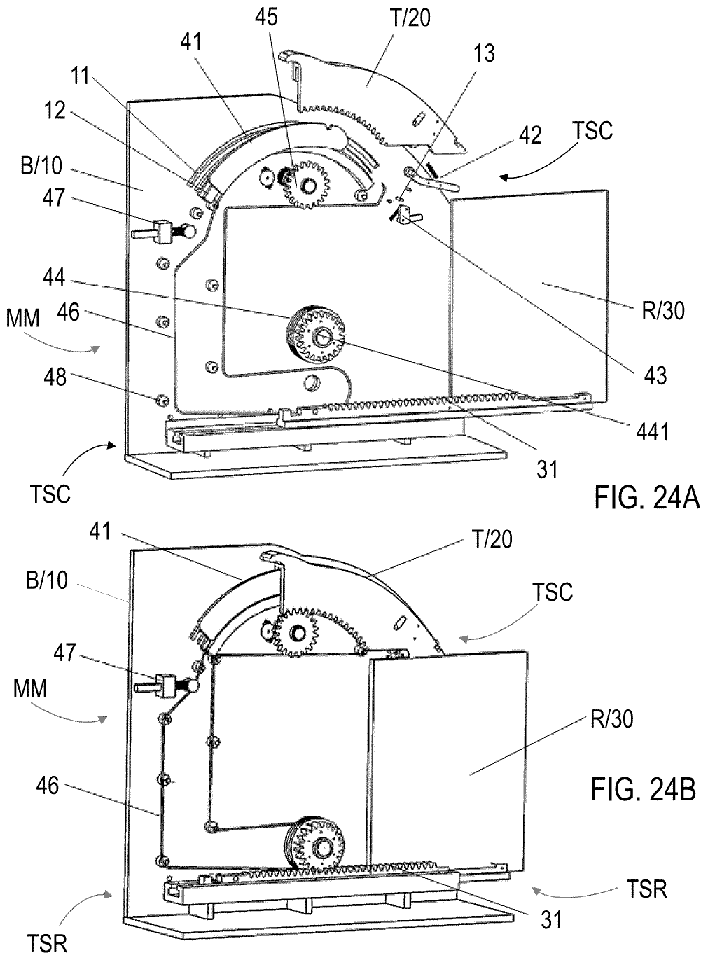

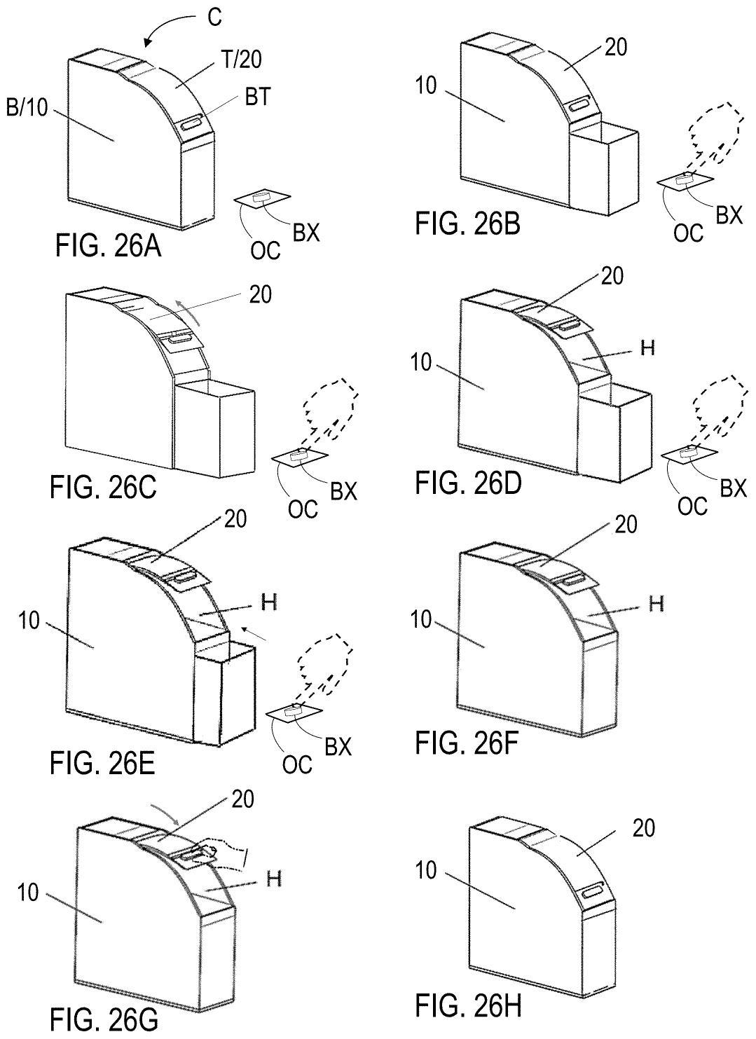

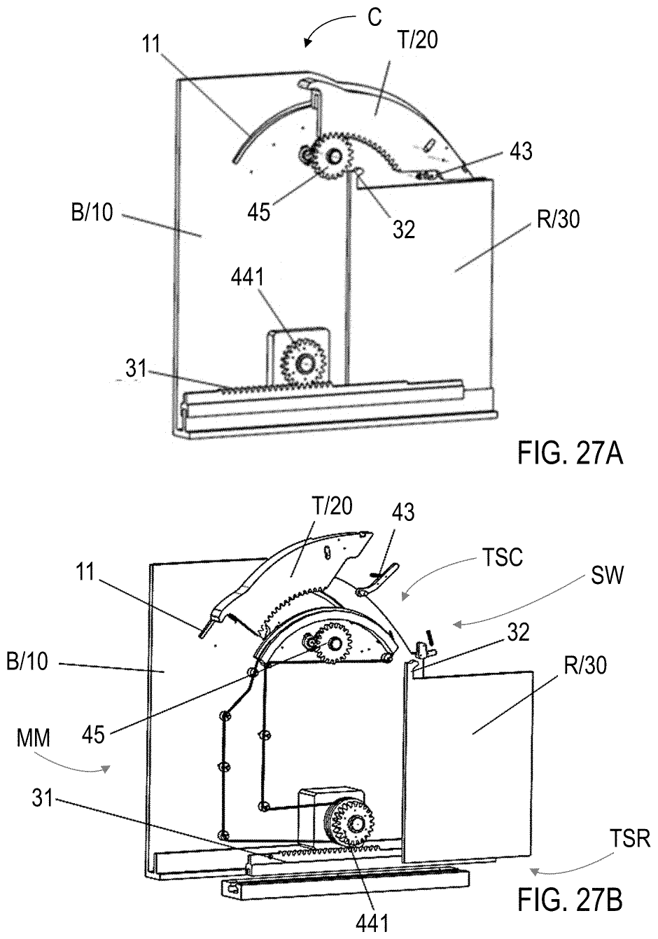

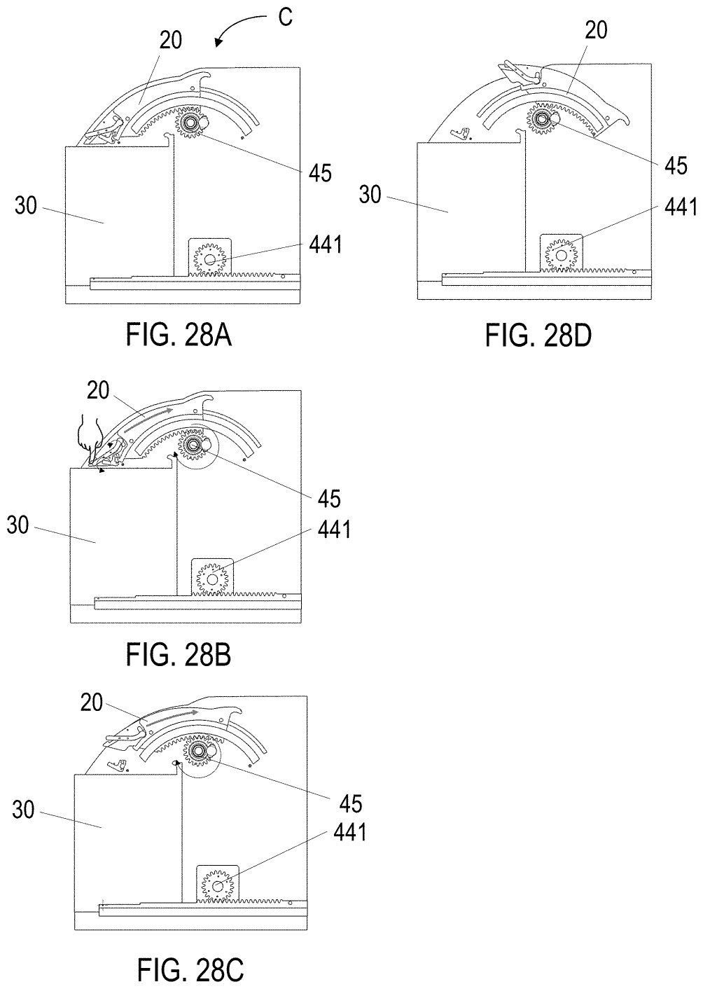

As shown schematically in FIGS. 2, 22A-22E, 23A-23G, 24A-24B and 27A-27B, the component may comprise a receptacle R configured to be movable relative to base B between a retracted position within base B and an extended position. See also FIGS. 26A-26H and 28A-28D. As indicated schematically in FIGS. 2 and 22A-22E, receptacle R may provide a compartment S. As shown schematically in FIGS. 27A-27B and 28A-28D, the component may comprise a mechanism configured to be actuated by movement of receptacle R from the retracted position toward the extended position; the mechanism may be configured to release a latch mechanism LM for movement of cover T toward the open position when receptacle R is moved toward the extended position; the mechanism may comprise a switch SW actuated by movement of receptacle R. As shown schematically in FIGS. 24A-24B and 27A-27B, receptacle R may be movable relative to base B on a track system TSR; track system TSR may comprise a gear track.

According to an exemplary embodiment as shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a component for a vehicle interior may comprise a base B comprising a compartment, a cover T configured to be movable relative to base B between a closed position and an open position, a motor-actuated mechanism MM configured to move cover T, and an operator control OC configured to operate movement of cover T. As shown schematically, cover T may be configured to be moved in at least one of a tension-actuated mode and/or a motor-actuated mode under actuation by motor-actuated mechanism MM. As shown schematically, operator control OC may comprise a button mechanism BT configured to release a latch mechanism LM and for movement of cover T in the tension-actuated mode; latch mechanism LM may comprise a spring-operated mechanism configured to retain cover T in the closed position and to release cover T for movement toward the open position.

As shown schematically in FIGS. 2 and 2A-2E, operator control OC may be configured to initiate movement of cover T in the motor-actuated mode. See also FIGS. 6A-6B. As shown schematically in FIGS. 2, 3A-3D and 12A-12B, the component may comprise a tension-actuated mechanism TM configured to use spring force to move cover T from the open position to the closed position in the tension-actuated mode; motor-actuated mechanism MM may comprise a cable-drive system operated by a motor to move cover T from the open position to the closed position in the motor-actuated mode. As shown schematically in FIGS. 2, 3A-3D and 12A-12B, operator control OC may comprise a button BT configured to initiate movement of cover T in the tension-actuated mode.

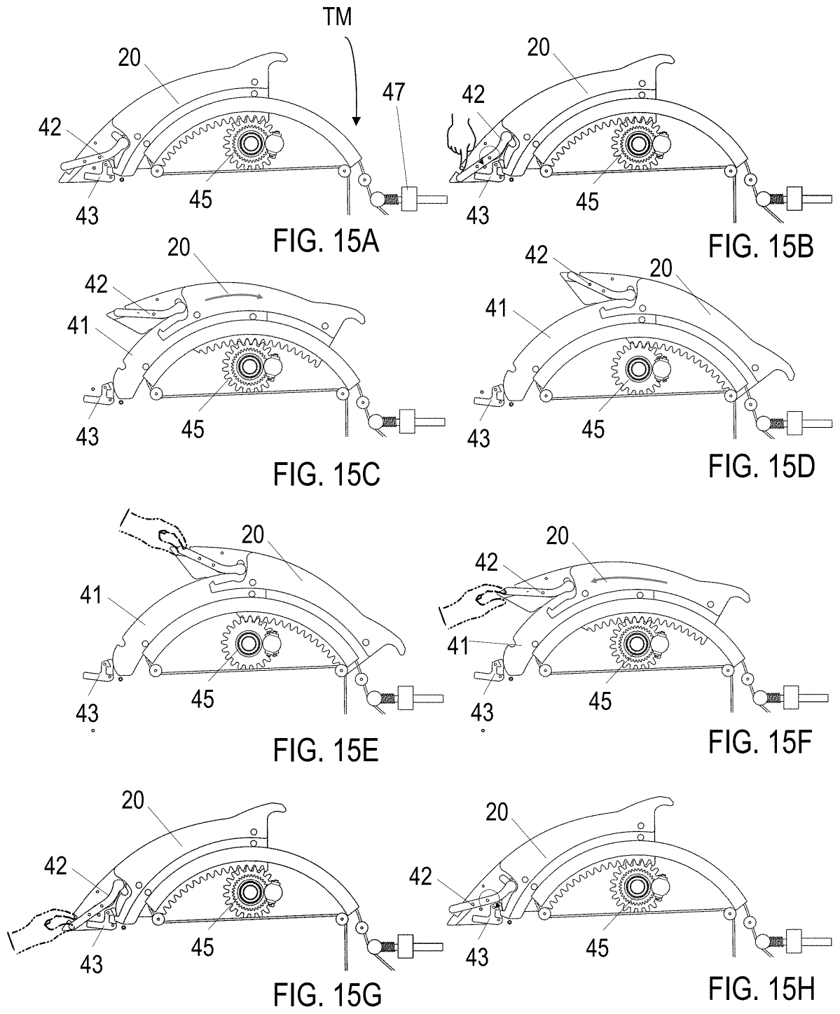

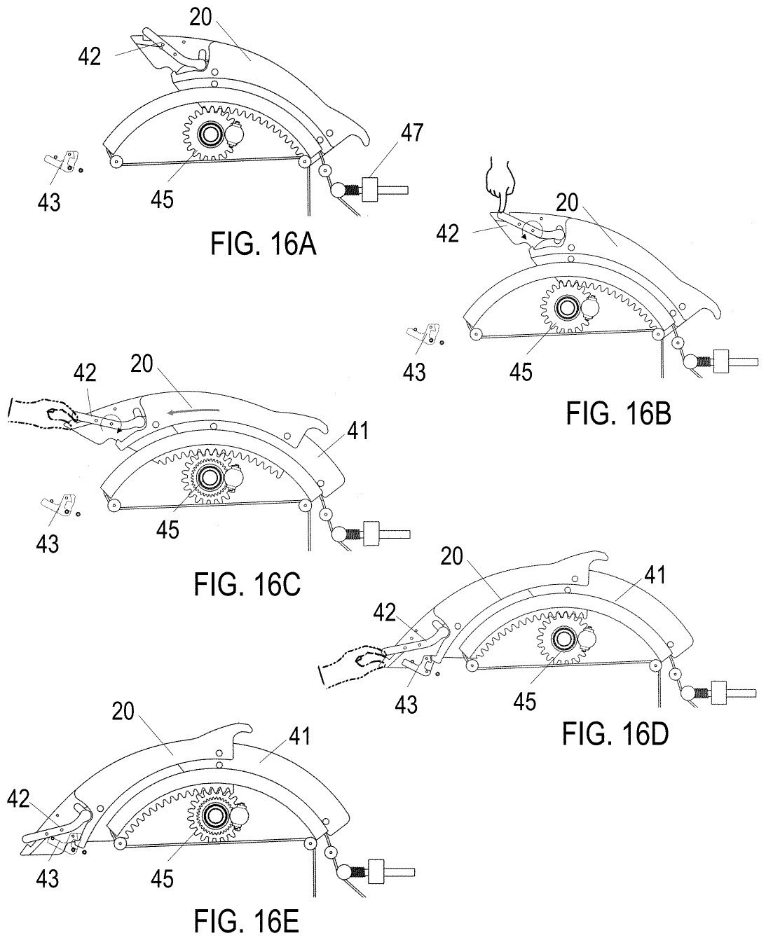

As shown schematically in FIGS. 3E-3F, 4D-4F and 5D-5F, cover T may be configured to be moved from the open position to the closed position in a manually-actuated mode. See also FIGS. 15E-15H and 16A-16E.

According to an exemplary embodiment as shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a component for a vehicle interior may comprise a base B comprising a compartment, a cover T configured to be movable relative to base B between a closed position and an open position, a spring-actuated mechanism TM configured to move cover T, a motor-actuated mechanism MM configured to move cover T, and an operator control OC configured to operate movement of cover T. Cover T may be configured to be moved in at least one of a spring-actuated mode under actuation of spring-actuated mechanism TM and/or a motor-actuated mode under actuation by motor-actuated mechanism MM. See FIGS. 2A-2E, 3A-3F, 4A-4J and 5A-5I.

As shown schematically in FIGS. 2 and 2A-2D, the component may comprise an operator control OCX shown with button arrangement/button BX configured to initiate movement of cover T in the motor-actuated mode. See also FIGS. 4A-4C, 5A-5C and 5H-5I.

As shown schematically according to an exemplary embodiment in FIGS. 2, 2A-2E, 3A-3F, 4A-4J, 5A-5I, 6A-6B, 12A-12B, 21A-21B, 22A-22E, 23A-23G, 24A-24B and 27A-27B, a component C for a vehicle interior configured to be operated by an operator control OC/OCX (with button BT/BX) may comprise a cover T movable relative to a base B between a closed position and an open position, a spring-actuated mechanism TM for cover T and a motor-actuated mechanism MM for cover T. Cover T may be moved in a tension/spring-actuated mode under actuation of spring-actuated mechanism TM and/or a motor-actuated mode under actuation by motor-actuated mechanism MM. Cover T may be configured to move on a track system TSC comprising a gear track. Motor-actuated mechanism MM may comprise a cable-drive system; spring-actuated mechanism TM may use spring/tension action to open cover T. The component may comprise a receptacle R movable between a retracted position and an extended position. The component may comprise a latch mechanism LM for cover T actuated by an operator control such as button BT and/or movement of receptacle R with switch/mechanism SW; the component may provide a manually-operated mode.

According to an exemplary embodiment as shown schematically in FIGS. 2A-2E, 3A-3F, 4A-4J, 6A-6B 12A-12B, 13A-13E, 14A-14E, 15A-15H, 16A-16E, 17A-17D, 18A-18D, 19A-19C, 20A-20B and 21A-21B, component C may be configured for operation to move cover T in a tension/spring-operated mode and/or manually-operated mode and/or motor/electric-operated mode. In a temporary fault/failure mode for the motor, the component may comprise a clutch mechanism to provide for manual operation and motor/electric-operation. See FIGS. 5A-5I.

### Exemplary Embodiments—A

According to an exemplary embodiment as schematically shown in FIGS. 1A-1B, a vehicle V may be provided with an interior component I including vehicle interior components such as an instrument panel IP and component C shown as a floor console FC with a vehicle interior trim/component.

As shown schematically in FIGS. 1A-1B and 2, a vehicle interior trim/component C (shown as a floor console FC) may comprise a base 10, base 10 comprises a storage compartment H, a cover 20 that is movable relative to base 10 is provided at an opening of storage compartment H; cover 20 is provided with an operator control OC providing a manual switch BT and moved by a driving mechanism between a first closed position (shown in FIG. 2A) where storage compartment H is covered and a first open position (shown in FIG. 2C) where storage compartment H is completely exposed.

As indicated schematically, cover 20 moves from the first closed position to the first open position and then from the first open position back to the first closed position in an electric mode, as shown schematically in FIGS. 2A-2E. As indicated schematically, cover 20 moves from the first closed position, by manually pressing a switch BT, to the first open position via an intermediate position; then back to the first closed position by manually pulling cover 20 in a manual mode, as shown schematically in FIGS. 3A-3F. As indicated schematically, the electric mode and the manual mode can be switched to at any time without affecting the opening and closing of cover 20. As indicated schematically, after cover 20 moves from the first closed position to the first open position via the intermediate position in the electric mode, the vehicle interior trim is switched to the manual mode; cover 20 can be locked by pulling cover 20 back to the first closed position after switch BT is manually pressed; can also be unlocked by pressing switch BT again, so that cover 20 can be moved from the first closed position to the first open position, as shown schematically in FIGS. 4A-4J. As indicated schematically, after cover 20 moves from the first closed position to the first open position via the intermediate position in the electric mode, the vehicle interior trim is switched to the manual mode; cover 20 is locked by pulling cover 20 back to the first closed position after switch BT is manually pressed; then cover 20 moves from the first closed position to the first open position in the electric mode, as shown schematically in FIGS. 5A-5I.

As shown schematically in FIGS. 6A-6B, a first sliding rail 11 and a second sliding rail 12 are mounted in parallel on an inner side of base 10; cover 20 may slide along first sliding rail 11. First sliding rail 11 and second sliding rail 12 may have a linear or curved shape, or other shapes according to actual needs.

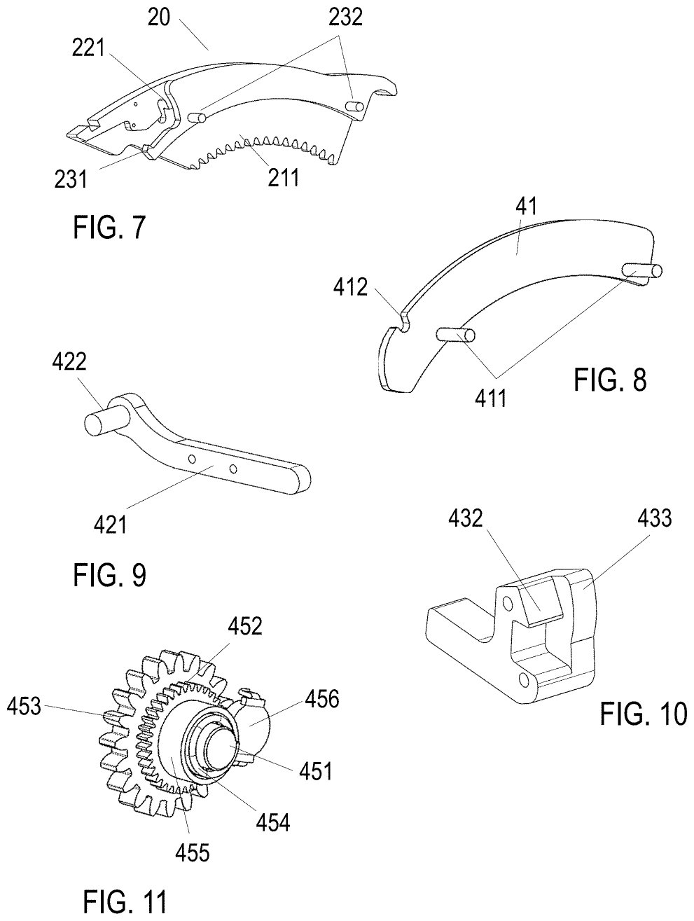

As shown schematically in FIG. 7, cover 20 comprises a first sidewall 21, a second sidewall 22 and a third sidewall 23 extending substantially in a vertical direction; first sidewall 21, second sidewall 22 and third sidewall 23 are substantially parallel. The bottom surface of first side wall 21 is provided with teeth 211, the bottom surface of second side wall 22 is provided with an unlocking slot 221; third side wall 23 has a locking tongue 231 protruding along its extending direction and is provided with a guide post 232 on its side surface. Guide posts 232 are mounted on first sliding rail 11 of base 10, so that cover 20 can slide along first sliding rail 11.

As shown schematically in FIGS. 6A-6B, the driving mechanism comprises a slide 41 adjacent to cover 20 and moving relative to base 10, a clutch lock 42 for controlling the connection and disconnection of cover 20 and slide 41, a cover lock 43 for securing cover 20 to base 10, a winder 44 mounted inside base 10, a power-assisted gear set 45 engaged with teeth 211 on cover 20; a cable 46 connected with both ends of slide 41.

As shown schematically in FIGS. 6B and 8, slide 41 is provided with a locking slot 412 on the top surface and a guide post 411 on the side surface; guide post 411 is mounted on second sliding rail 12 of base 10, so that slide 41 can slide along second sliding rail 12. Cable 46 is connected with both ends of slide 41 and wraps around winder 44. Winder 44 is driven by a motor 49 to move cable 46, so that slide 41 can reciprocate along second rail 12. According to an exemplary embodiment shown schematically, base 10 is mounted with a tension pulley 47 and a multi-alignment cable pulley 48 to provide pre-tension to cable 46, and cable 46 wraps around tension pulley 47 and cable pulley 48, such that the cable has a more stable movement and a more flexible arrangement. A cable slot structure 15 is provided in parallel with first sliding rail 11 and second sliding rail 12 to support and guide cables.

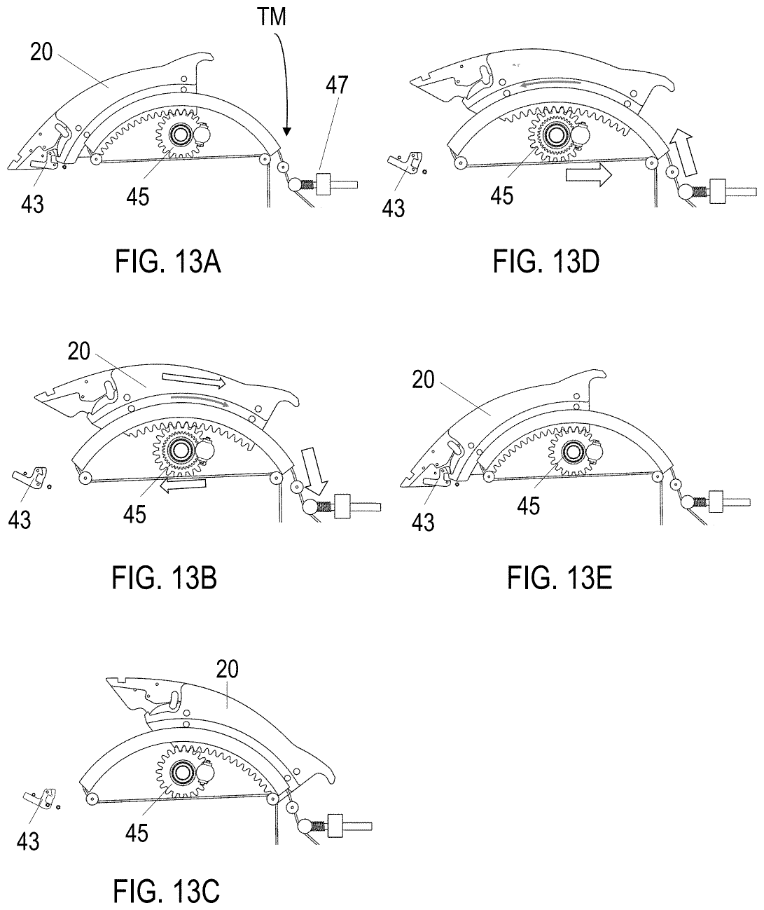

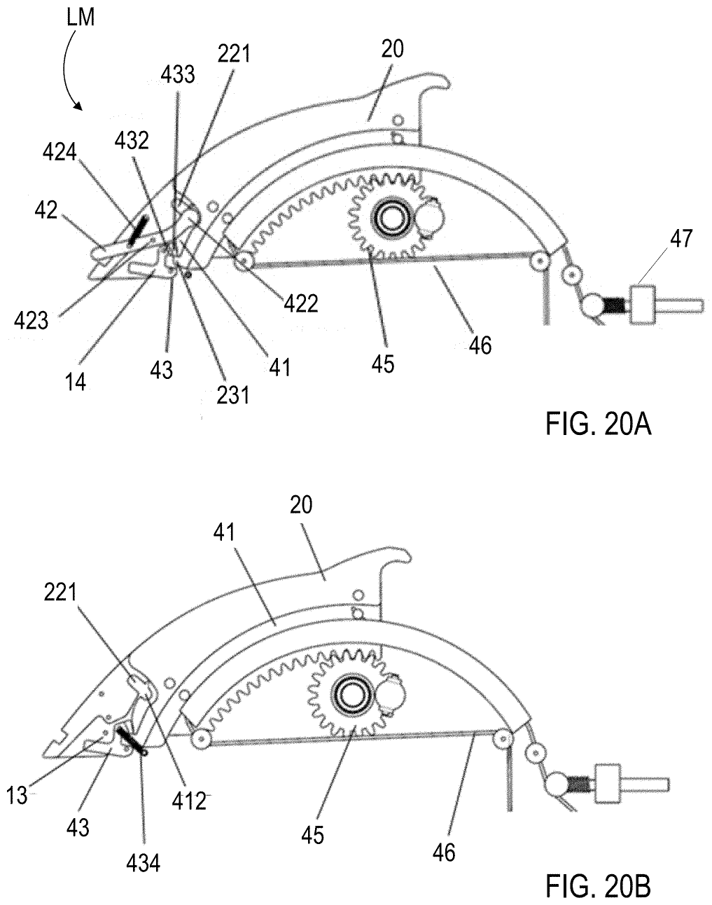

As shown schematically in FIGS. 9 and 12A, clutch lock 42 comprises a lock rod 421 and a locking head 422 fixed to an end of lock rod 421. Clutch lock 42 is pivotally connected to cover 20 by a first rotating shaft 423. A first tension spring 424 has one end fixed to lock rod 421 and the other end fixed to cover 20. As shown schematically in FIGS. 13A and 20B, unlocking slot 221 on cover 20 is aligned with locking slot 412 on slide 41 when cover 20 and slide 41 are in the first closed position. As shown schematically in FIGS. 13B-13E, unlocking slot 221 is aligned with locking slot 412 when cover 20 and slide 41 are moved synchronously to other same positions. As shown schematically in FIG. 20A, first tension spring 424 applies a tensile force to lock rod 421 to rotate the lock rod clockwise around first rotating shaft 423, and drives locking head 422 to be inserted into locking slot 412 of slide 41, so that clutch lock 42 can keep moving synchronously with slide 41. As indicated schematically in FIG. 15B, the other end of lock rod 421 is connected with a manual switch; when manual switch BT is pressed, an external force is applied to lock rod 421 to counteract the tensile force of first tension spring 424, such that lock rod 421 rotates counterclockwise around first rotating shaft 423 and drives locking head 422 to be inserted into unlocking slot 221 of cover 20.

As shown schematically in FIGS. 10 and 12A, cover lock 43 comprises a locking hook 432 and an eccentric structure 433 adjacent to locking hook 432 and is pivotally connected to base 10 by a second rotating shaft 431. A second tension spring 434 has one end fixed to locking hook 432 and the other end fixed to base 10. As shown schematically in FIG. 16E, when cover 20 is in the closed state, second tension spring 434 applies a tensile force to cover lock 43 to rotate the cover lock clockwise about second rotating shaft 431, such that locking hook 432 is hooked with locking tongue 231 on cover 20 securing cover 20 to base 10. The center of the curvature of any position of the curved surface of eccentric structure 433 and the center of the rotation of cover lock 43 are located on the same side. As shown schematically in FIGS. 13A, 14A and 15A, slide 41 pushes cover lock 43 to rotate counterclockwise around second rotating shaft 431 when eccentric structure 433 contacts with slide 41, such that locking hook 432 is disengaged from locking tongue 231. As shown schematically in FIGS. 6B and 12B, a stop rod 13 for limiting cover lock 43 is provided on base 10, for limiting the position of cover lock 43 after being rotated clockwise under the action of second tension spring 434 after locking hook 432 is disengaged from locking tongue 231.

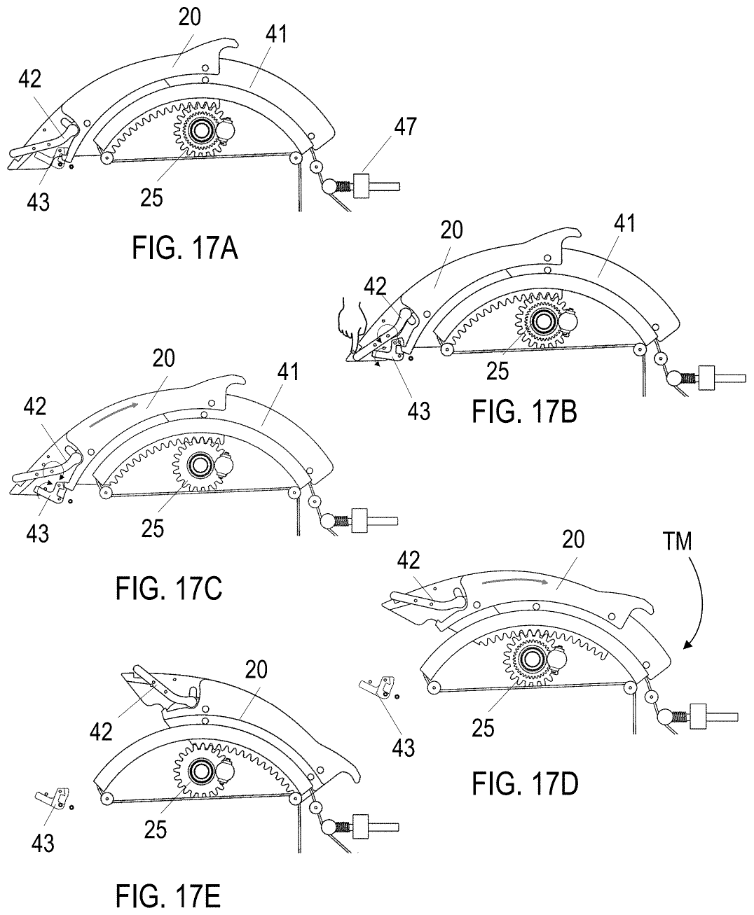

As shown schematically in FIGS. 11 and 12A, power-assisted gear set 45 comprises a fixed shaft 451, and an inner gear 452, an outer gear 453, a torsion spring 454, and a bearing 455 that are coaxially arranged on fixed shaft 451. Torsion spring 454 is sleeved on fixed shaft 451 and located inside outer gear 453 to accumulate force to boost the opening of cover 20, as shown schematically in FIGS. 15C and 17C-17D. Power-assisted gear set 45 is mounted on base 10 by fixed shaft 451; outer gear 453 is engaged with teeth 211 of cover 20. Power-assisted gear set 45 comprises a damper 456 engaged with inner gear 452 and transmits a damping force to outer gear 453 through a transmission action of inner gear 452, so that cover 20 can be smoothly opened and closed.

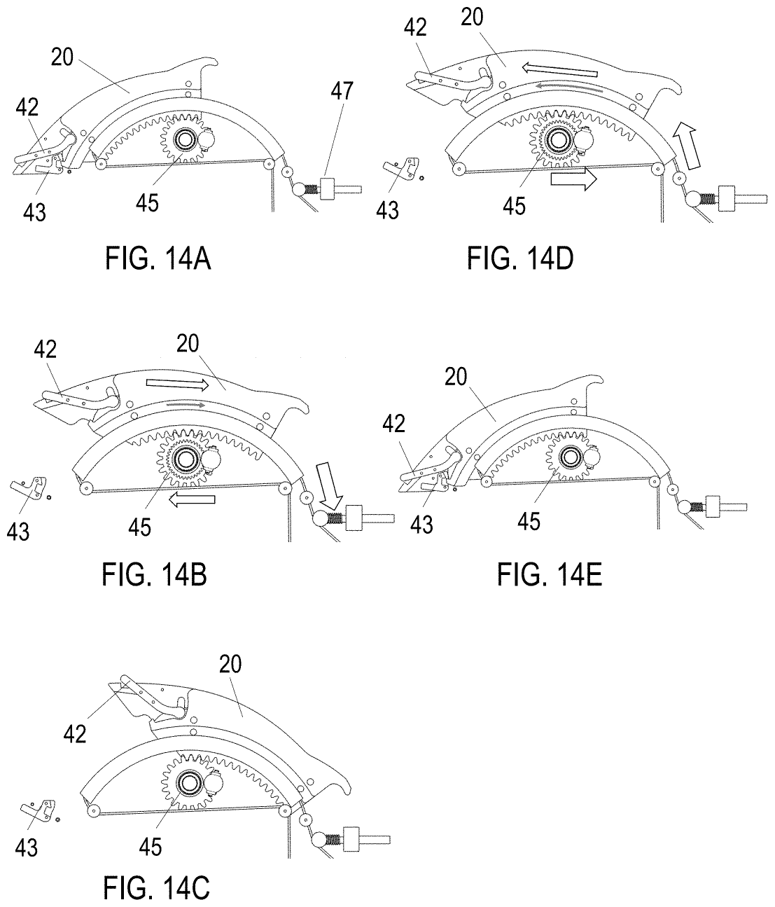

As indicated schematically according to an exemplary embodiment, when cover 20 is in the first closed position, the tensile force applied by second tension spring 434 to cover lock 43 is overcome due to slide 41 abutting against eccentric structure 433 of cover lock 43, such that locking hook 432 on cover lock 43 is kept disconnected from locking tongue 231 on cover 20, as shown schematically in FIG. 13A; unlocking slot 221 of cover 20 is aligned with locking slot 412 of slide 41; the tensile force applied by first tension spring 424 to lock rod 421 enables locking head 422 to rotate clockwise around first rotating shaft 423 and to be inserted into locking slot 412 of slide 41, as shown schematically in FIG. 14A ensuring synchronous movement of cover 20 and slide 41.

As shown schematically in FIGS. 13A-13C and 14A-14C, motor 49 drives winder 44 to rotate when cover 20 moves from the first closed position to the first open position in the electric mode driving cable 46 to pull slide 41 to move toward the first open position. Cover 20 is connected with slide 41 by clutch lock 42 and moves synchronously with slide 41; the force applied to cover lock 43 by slide 41 against second tension spring 434 gradually disappears as slide 41 gradually moves away from cover lock 43; cover lock 43 rotates clockwise under the tensile force of second tension spring 434 until the cover lock stops against stop rod 13 on base 10. Cover 20 can move smoothly from the first closed position to the first open position due to the engagement of teeth 211 on cover 20 and external gear 453 of power-assisted gear set 45.

As shown schematically in FIGS. 13C-13E and 14C-14E, motor 49 drives winder 44 to rotate reversely when cover 20 moves from the first open position to the first closed position in the electric mode, which in turn drives cable 46 to pull slide 41 to move reversely. See also FIGS. 4A-4F. Since cover 20 and slide 41 are always connected and kept in synchronous movement under the action of clutch lock 42, slide 41 drives cover 20 to return to the first closed position; slide 41 contacts eccentric structure 433 of cover lock 43 and pushes cover lock 43 to rotate counterclockwise to return to the first closed position.

According to an exemplary embodiment as shown schematically in FIGS. 2 and 5A-5I, vehicle interior trim/component C may be configured to be opened and closed manually if/when the electric mode fails or the vehicle interior trim/component does not work normally.

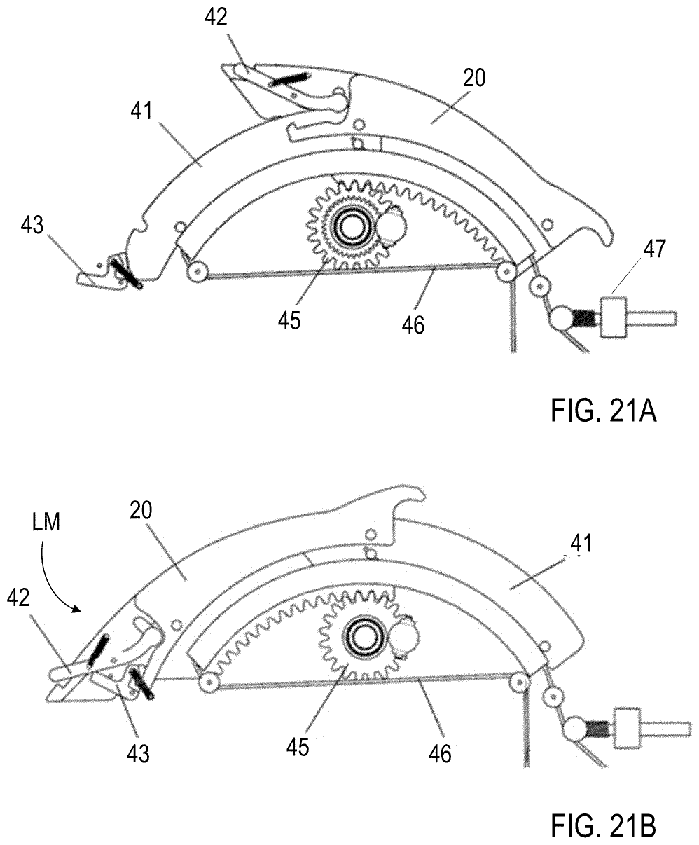

As shown schematically in FIGS. 15A-15D, when cover 20 and slide 41 are in the first closed position and motor 49 fails, occupants/passengers may open the cover with manual switch BT on cover 20, such that an external force is applied to clutch lock 42 to overcome the tensile force of first tension spring 424 triggering clutch lock 42 to rotate counterclockwise, such that locking head 422 of clutch lock 42 is disconnected from locking slot 412 of slide 41 and enters unlocking slot 221 aligned with locking slot 412, that is, cover 20 is disconnected from slide 41, as shown schematically in FIG. 15B. Cover 20 can move smoothly under the action of power-assisted gear set 45; locking head 422 of clutch lock 42 moves along with movement of cover 20 and abuts against the upper surface of slide 41 until cover 20 moves to the first open position while slide 41 remains in the first closed position, as shown schematically in FIG. 21A.

As indicated schematically in FIGS. 15E-15H, occupants/passengers may close the cover with direct pull of cover 20 manually, such that locking head 422 of clutch lock 42 moves against the upper surface of slide 41 until locking head 422 moves to the position of locking slot 412, and falls into locking slot 412 of slide 41 under the action of first tension spring 424, that is, cover 20 is reconnected with slide 41; cover 20 returns to the first closed position.

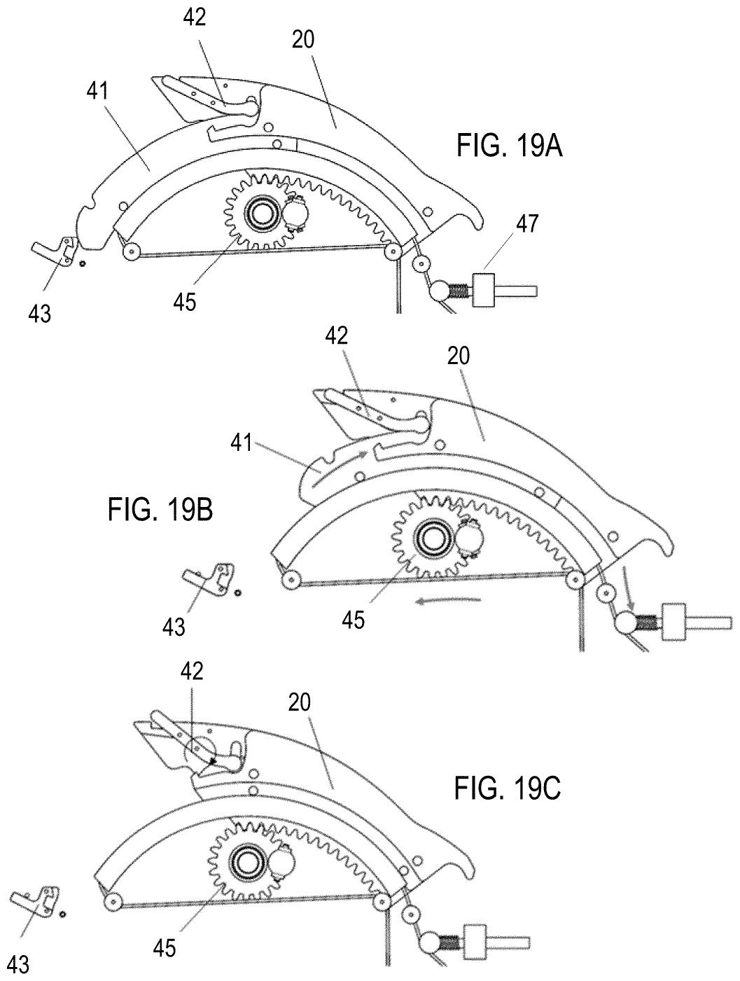

As shown schematically in FIGS. 19A-19C, when cover 20 has moved to the first open position and slide 41 remains in the first closed position, motor 49 resumes operating and thus drives slide 41 to move toward the first open position; as slide 41 moves, locking head 422 of clutch lock 42 moves against the upper surface of slide 41 until locking head 422 is aligned with locking slot 412 of slide 41; locking head 422 falls into locking slot 412 of slide 41 under the action of first tension spring 424; cover 20 is reconnected with slide 41; slide 41 moves to the first closed position.

As shown schematically in FIGS. 16A-16E, when cover 20 and slide 41 are in the first open position, cover lock 43 has stopped after rotating clockwise to stop rod 13 on base 10 under the tensile force of second tension spring 434. If motor 49 fails at the time and passengers want to close the cover, they can press manual switch BT on cover 20, such that an external force is applied to clutch lock 42 to overcome the tensile force of first tension spring 424 triggering clutch lock 42 to rotate counterclockwise, such that locking head 422 of clutch lock 42 is disconnected from locking slot 412 of slide 41 and enters unlocking slot 221 aligned with locking slot 412, that is, cover 20 is disconnected from slide 41. As indicated schematically, cover 20 may be manually pulled to move to the first closed position until locking tongue 231 of cover 20 and locking hook 432 of cover lock 43 are hooked to each other to lock cover 20; slide 41 still remains in the first open position, as shown schematically in FIGS. 21B and 16E.

As indicated schematically in FIGS. 17A-17E, occupants/passengers may open the cover with manual switch BT, such that clutch lock 42 rotates counterclockwise and pushes cover lock 43 to rotate counterclockwise; locking hook 432 of cover lock 43 is disengaged from locking tongue 231 of cover 20. Cover 20 is unlocked and smoothly opened under the action of power-assisted gear set 45; locking head 422 of clutch lock 42 is inserted into locking slot 412 of slide 41 when cover 20 moves to the first open position, such that cover 20 is connected to slide 41 again.

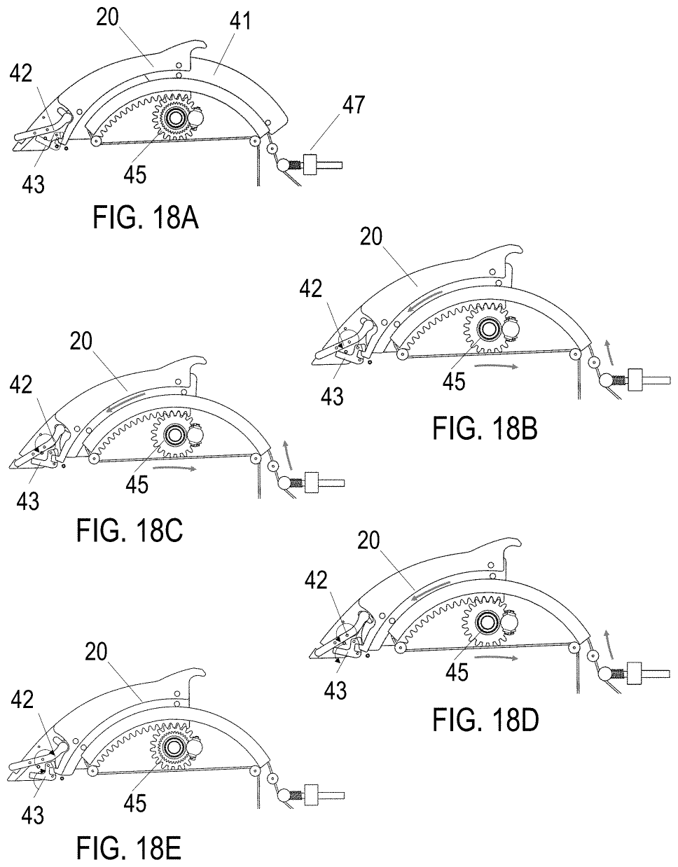

As shown schematically in FIGS. 18A-18E, when cover 20 returns to the first closed position and is locked with cover lock 43 while slide 41 remains in the first open position, if motor 49 resumes operating again, motor 49 drives slide 41 to move toward the first closed position until a front end of slide 41 contacts eccentric structure 433 of cover lock 43 and pushes cover lock 43 to disconnect from locking tongue 231 of cover 20; locking head 422 of clutch lock 42 slides into locking slot 412 on slide 41, such that cover 20 is changed from being locked with cover lock 43 to being locked with slide 41 ensuring stability of cover 20.

According to an exemplary embodiment, the component may comprise a movable storage box 30 moving between a second closed position and a second open position relative to a base 10; movable storage box 30 comprises a storage compartment S. As shown schematically in FIG. 22A, movable storage box 30 is located inside base 10 when it is in the second closed position; storage compartment S is invisible; as shown schematically in FIG. 22C, when movable storage box 30 protrudes from base 10 when it is in the second open position; storage compartment S is visible.

As shown schematically in FIGS. 22A-22E, as movable storage box 30 moves from the second closed position toward the second open position in the electric mode, cover 20 also moves from the first closed position toward the first open position simultaneously until movable storage box 30 moves to the second open position and cover 20 moves to the first open position; conversely, as movable storage box 30 moves from the second open position toward the second closed position, cover 20 also moves from the first open position toward the first closed position simultaneously until movable storage box 30 returns to the second closed position and cover 20 returns to the first closed position.

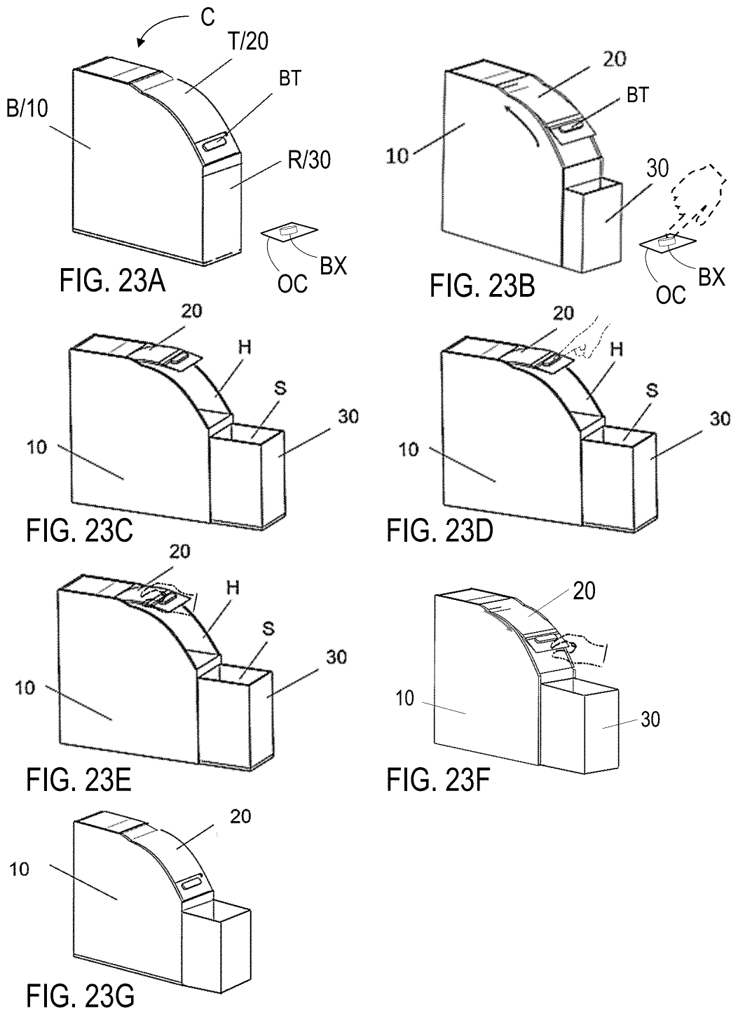

As shown schematically in FIGS. 23A-23G, after movable storage box 30 and cover 20 are moved to the second open position and the first open position in the electric mode; the vehicle interior trim is switched to the manual mode; switch BT on cover 20 is manually pressed; then cover 20 is manually pulled back to the first closed position.

As shown schematically in FIGS. 24A-24B, a rack 31 is provided at the bottom of movable storage box 30, a first gear 441 is provided on winder 44; rack 31 is engaged with first gear 441. A motor may be configured to drive movable storage box 30 to move.

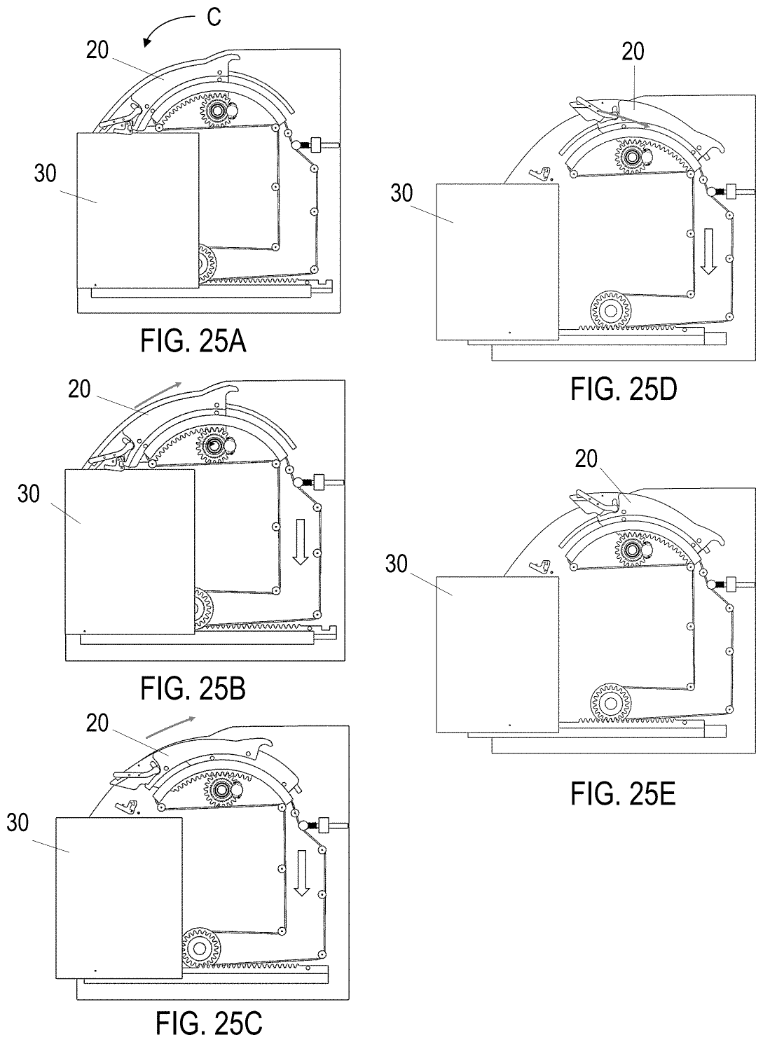

As shown schematically in FIGS. 25A-25E, when motor 49 drives movable storage box 30 to move, rack 31 on movable storage box 30 also moves synchronously, which in turn drives first gear 441 engaged with rack 31 to rotate, and then drives winder 44 coaxial with first gear 441 to rotate, so as to drive cable 46 to pull slide 41 to move, and then drive cover 20 connected to slide 41 to move synchronously. As indicated schematically, cover 20 and movable storage box 30 move synchronously, so that specific requirements can be met; the vehicle interior trim of the present invention features a simple structure and a low cost.

As shown schematically in FIGS. 27A-27B, the component may be provided with a push rod 32 on movable storage box 30, forming another sliding mechanism together with rack 31 and first gear 441. Push rod 32 is a convex structure with an outer contour of a curved surface.

As shown schematically in FIGS. 26A-26B, cover 20 and movable storage box 30 are in a first closed position and a second closed position As movable storage box 30 moves toward the first open position in the electric mode, cover 20 remains in the first closed position, as shown schematically in FIGS. 26C-26D; cover 20 does not move from the first closed position toward, and finally to, the first open position until movable storage box 30 moves to the first open position. As shown schematically in FIGS. 26E-26F, as movable storage box 30 moves toward the first closed position in the electric mode, cover 20 remains in the first open position until movable storage box 30 moves to the first closed position. Cover 20 can be closed by manually pulling cover 20 from the first open position back to the first closed position, as shown schematically in FIGS. 26G-26H.

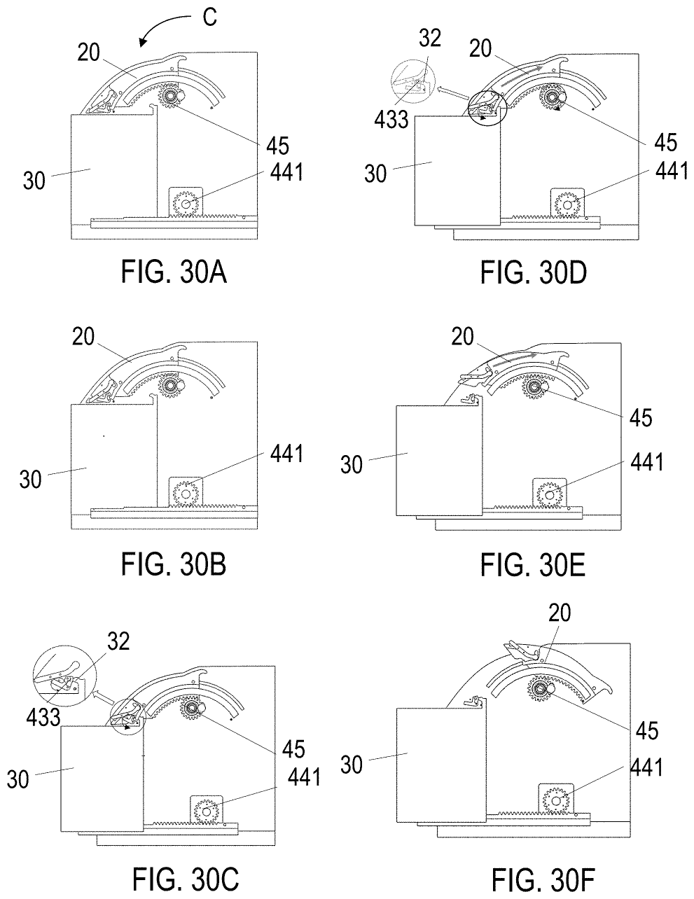

As shown schematically in FIGS. 30A-30F, push rod 32 is away from cover lock 43 when movable storage box 30 is in the second closed position. As indicated schematically, cover 20 is connected with cover lock 43 to fix cover 20 in the first closed position. Cover 20 is released from base 10 when movable storage box 30 moves to the second open position.

As indicated schematically, when cover 20 moves from the first closed position toward the first open position, as shown schematically in FIG. 30B, motor 49 drives first gear 441 to rotate driving rack 31 engaged with first gear 441 to move, that is, driving movable storage box 30 connected to rack 31 to move. As shown schematically in FIGS. 30C-30D, as movable storage box 30 is opened, push rod 32 gradually approaches cover lock 43 until it contacts eccentric structure 433 of cover lock 43, so as to push cover lock 43 to rotate clockwise, disengaging locking hook 432 of cover lock 43 from locking tongue 231 of cover 20, such that cover 20 is unlocked and moves to the open position along first sliding rail 11 under the action of torsion spring 454, as shown schematically in FIGS. 30E-30F.

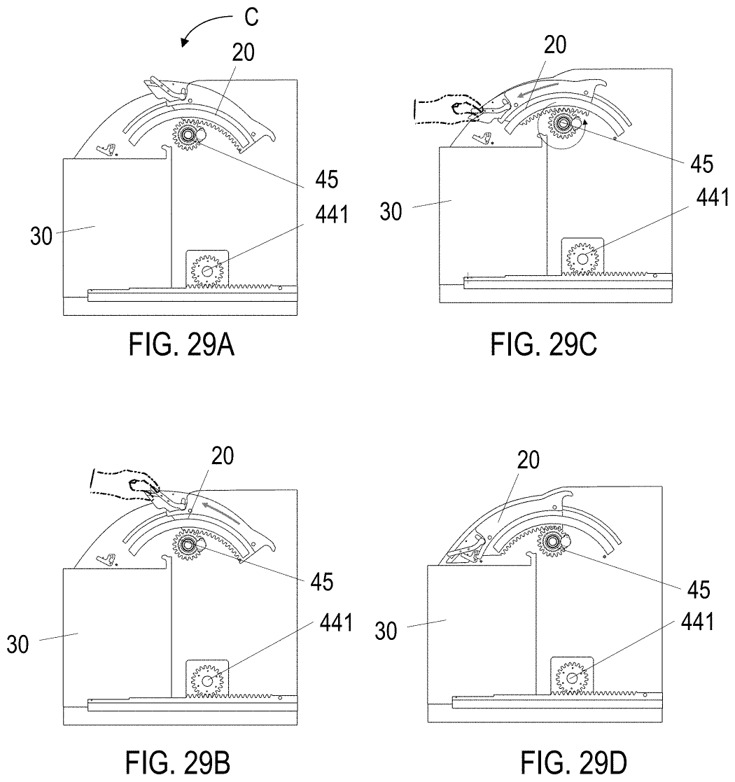

As shown schematically in FIGS. 29A-29D, movable storage box 30 is driven to return to the second closed position when the motor drives first gear 441 to rotate reversely. As push rod 32 of movable storage box 30 gradually moves away from cover lock 43, the force applied to cover lock 43 by push rod 32 against second tension spring 434 gradually disappears; cover lock 43 rotates counterclockwise under the tension of tension spring 434 until the cover lock stops against stop rod 13 on base 10. As indicated schematically, it is only necessary to manually pull cover 20 back to the first closed position until cover 20 is locked with cover lock 43.

As shown schematically in FIGS. 28A-28D, when cover 20 and movable storage box 30 are in the respective closed positions and motor 49 fails, occupants/passengers may open the cover with manual switch BT, such that clutch lock 42 rotates counterclockwise and pushes cover lock 43 to rotate counterclockwise, and locking hook 432 of cover lock 43 is disengaged from locking tongue 231 of cover 20, such that cover 20 is released from base 10. Cover 20 is unlocked and smoothly moved to the first open position under the action of power-assisted gear set 45, and movable storage box 30 remains in the second closed position.

### Exemplary Embodiments—B

As shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a vehicle interior component/trim component C may comprise a base B having a storage compartment H and a cover T; the cover may be configured to be movable, relative to the base, between a first closed position where the storage compartment may is retracted and a first open position where the storage compartment is exposed in both an electric mode and a manual mode. The interior trim/component may comprise a slide driven by a motor and moving, relative to the base, between the first closed position and the first open position. The cover may be configured to move in the electric mode when the cover is connected with the slide, and the cover may be configured to move in the manual mode when the cover is disconnected from the slide. The interior trim/component may comprise a clutch lock for operating the connection and disconnection of the cover with the slide. The cover may be provided with a switch, and the clutch lock may be configured to realize the connection or disconnection of the cover with the slide in response to pressure applied to the switch. The slide may comprise a locking slot, and the cover may comprise an unlocking slot; the cover is connected with the slide when a locking head of the clutch lock is positioned in the locking slot, and the cover is disconnected from the slide when the locking head of the clutch lock is positioned in the unlocking slot. The clutch lock may be disposed on the cover and rotated relative to the cover, such that the clutch lock moves from the locking slot into the unlocking slot or from the unlocking slot into the locking slot. The clutch lock may be connected with the cover by a first tension spring that acts on the clutch lock to retain the locking head of the clutch lock in the locking slot. The locking slot may be aligned with the unlocking slot when the cover and the slide are in a same position. The interior trim/component may comprise a cover lock; the cover may be connected with the cover lock when the slide moves away from the first closed position such that the cover is secured in the first closed position. The cover lock may be configured to rotate in response to the pressure applied to the switch when the cover is connected with the cover lock such that the cover lock is disconnected from the cover. The cover lock may be configured to connect with the cover when the slide is in the first closed position. The cover lock may be connected with the base by a second tension spring. The base may be provided with a stop rod, and the stop rod may be configured to define a position of the cover lock under the action of the second tension spring when the slide moves away from the cover lock. Both ends of the slide may be connected with a cable wrapping around a winder. The winder may be connected with the motor to move the slide. The interior trim/component may comprise a movable storage box connected with the motor; movement of the storage box rotates the winder and thereby moves the slide.

As shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a vehicle interior component/trim component may comprise a base having a storage compartment, a cover and a movable storage box; the cover may be configured to be movable relative to the base between a first closed position where the storage compartment is covered and a first open position where the storage compartment is exposed in both an electric mode and a manual mode, and the movable storage box may be configured to move between a second closed position within the base and a second open position where the movable storage box protrudes from the base. The movable storage box may be powered by a motor. The cover may be secured to the base by a cover lock when the cover is in the first closed position. The cover may be released from the base when the movable storage box moves to the second open position. The movable storage box may comprise a push rod, and the push rod contacts and pushes the cover lock to rotate when the movable storage box moves toward the second open position. The interior trim/component may comprise a clutch lock provided on the cover; the rotation of the clutch lock rotates the cover lock when the cover is in the first closed position to release the cover from the base. The cover may be provided with a switch; the clutch lock may be configured to rotate in response to pressure applied to the switch to release the cover from the base. The cover moves from the first closed position toward the first open position in response to movement of the movable storage box from the second closed position toward the second open position. The cover moves from the first open position toward the first closed position in response to movement of the movable storage box from the second open position toward the second closed position. The cover may be movable between the first closed position and a first open position when the movable storage box is in any position between the second closed position and the second open position. The cover remains in the first open position when the movable storage box moves from the second open position toward the second closed position.

As shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a vehicle interior component/trim component may comprise a base configured to provide a storage compartment; a cover configured to move, relative to the base, between a first closed position where the storage compartment is covered and a first open position where an access to the storage compartment is provided; and a mechanism configured to drive the cover to move between the first closed position and the first open position; the cover may be configured for an engaged state in which the cover is engaged with the mechanism and a disengaged state in which the cover is disengaged from the mechanism. The mechanism may comprise a motor configured to move the cover between a first closed position and a first open position when the cover is in the engaged state. The vehicle interior component may comprise a connector configured to connect the cover to the mechanism to provide the engaged state. The connector may comprise a slide. The mechanism may be configured to move the connector to move the cover between the first closed position and the first open position. The vehicle interior component may comprise an electrical cable configured to connect the connector with the mechanism and a clutch lock configured to disconnect the cover from the mechanism to provide the disengaged state. The cover may be configured to move between the first closed position and the first open position in response to an external force applied to the cover when the cover is in the disengaged state. The external force may comprise at least one of a force applied to the cover by a hand and a force applied to the cover by a torsion spring. The vehicle interior component may comprise a storage box configured to move, relative to the base, between a second closed position where the storage box is stored and a second open position where an access to the storage box is provided. The cover may be configured to move from the first closed position toward the first open position when the storage box moves from the second closed position toward the second open position. The cover may be configured to move from the first open position toward the first closed position when the storage box moves from the second open position toward the second closed position. The cover may be configured to move from the first closed position toward the first open position or from the first open position toward the first closed position when the storage box is in the second closed position.

As shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a vehicle interior component/trim component may comprise the clutch lock and the cover lock that interact in an electric state and a manual state, operating the opening and closing of the interior trim/component in the manual state and the electric state. As shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, a vehicle interior component/trim component may comprise a structure configured for use in an interior trim/component involving both electric operation and manual operation.

According to an exemplary embodiment shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, the component may comprise a base having a storage compartment and a cover. The cover may be configured to be movable relative to the base between a first closed position where the storage compartment is covered and a first open position where the storage compartment is exposed in both an electric mode and a manual mode. The component may comprise a slide driven by a motor and moving relative to the base between the first closed position and the first open position. The cover may be configured to move in the electric mode when the cover is connected with the slide, and the cover may be configured to move in the manual mode when the cover is disconnected from the slide. The component may comprise a clutch lock for operating the connection and disconnection of the cover with the slide. The cover may be provided with a switch, and the clutch lock may be configured to realize the connection or disconnection of the cover with the slide in response to pressure applied to the switch. The slide may comprise a locking slot, and the cover may comprise an unlocking slot. The cover may be connected with the slide when a locking head of the clutch lock is positioned in the locking slot, and the cover may be disconnected from the slide when the locking head of the clutch lock is positioned in the unlocking slot. The clutch lock may be disposed on the cover and rotated relative to the cover such that the clutch lock moves from the locking slot into the unlocking slot or from the unlocking slot into the locking slot. The clutch lock may be connected with the cover by a first tension spring that may act on the clutch lock to retain the locking head of the clutch lock in the locking slot. The locking slot may be aligned with the unlocking slot when the cover and the slide are in a same position. The interior trim/component may comprise a cover lock. The cover may be connected with the cover lock when the slide moves away from the first closed position such that the cover is secured in the first closed position. The cover lock may be configured to rotate in response to the pressure applied to the switch when the cover is connected with the cover lock such that the cover lock is disconnected from the cover. The cover lock may be configured to connect with the cover when the slide is in the first closed position. The cover lock may be connected with the base by a second tension spring. The base may be provided with a stop rod, and the stop rod may be configured to define a position of the cover lock under the action of the second tension spring when the slide moves away from the cover lock. Both ends of the slide may be connected with a cable wrapping around a winder. The winder may be connected with the motor to move the slide. The component may comprise a movable storage box connected with the motor. Movement of the storage box may rotate the winder and thereby move the slide.

According to an exemplary embodiment shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, the component may comprise a base having a storage compartment, a cover and a movable storage box. The cover may be configured to be movable relative to the base between a first closed position where the storage compartment is covered and a first open position where the storage compartment is exposed in both an electric mode and a manual mode. The movable storage box may be configured to move between a second closed position within the base and a second open position where the movable storage box protrudes from the base. The movable storage box may be powered by a motor. The cover may be secured to the base by a cover lock when the cover is in the first closed position. The cover may be released from the base when the movable storage box moves to the second open position. The movable storage box may comprise a push rod. The push rod may contact and push the cover lock to rotate when the movable storage box moves toward the second open position. The component may comprise a clutch lock provided on the cover. Rotation of the clutch lock may rotate the cover lock when the cover is in the first closed position to release the cover from the base. The cover may be provided with a switch. The clutch lock may be configured to rotate in response to pressure applied to the switch to release the cover from the base. The cover may move from the first closed position toward the first open position in response to movement of the movable storage box from the second closed position toward the second open position. The cover may move from the first open position toward the first closed position in response to movement of the movable storage box from the second open position toward the second closed position. The cover may be movable between the first closed position and a first open position when the movable storage box is in any position between the second closed position and the second open position. The cover may remain in the first open position when the movable storage box moves from the second open position toward the second closed position.

According to an exemplary embodiment shown schematically in FIGS. 2, 2A-2E, 3A-3F, 4A-4J, 5A-5I, 6A-6B, 12A-12B, 21A-21B, 22A-22E, 23A-23G, 24A-24B and 27A-27B, the component may comprise a base configured to provide a storage compartment, a cover configured to move relative to the base between a first closed position where the storage compartment is covered and a first open position where an access to the storage compartment is provided, and a mechanism configured to drive the cover to move between the first closed position and the first open position. The cover may be configured for an engaged state in which the cover is engaged with the mechanism and a disengaged state in which the cover is disengaged from the mechanism. The mechanism may comprise a motor configured to move the cover between the first closed position and the first open position when the cover is in the engaged state. The vehicle interior component may comprise a connector configured to connect the cover to the mechanism to provide the engaged state. The connector may comprise a slide. The mechanism may be configured to move the connector to move the cover between the first closed position and the first open position. The vehicle interior component may comprise an electrical cable configured to connect the connector with the mechanism. The vehicle interior component may comprise a clutch lock configured to disconnect the cover from the mechanism to provide the disengaged state. The cover may be configured to move between the first closed position and the first open position in response to an external force applied to the cover when the cover is in the disengaged state. The external force may comprise at least one of a force applied to the cover by a hand and a force applied to the cover by a torsion spring. The vehicle interior component may comprise a storage box configured to move relative to the base between a second closed position where the storage box is stored and a second open position where an access to the storage box is provided. The cover may be configured to move from the first closed position toward the first open position when the storage box moves from the second closed position toward the second open position. The cover may be configured to move from the first open position toward the first closed position when the storage box moves from the second open position toward the second closed position. The cover may be configured to move from the first closed position toward the first open position or from the first open position toward the first closed position when the storage box is in the second closed position.

### Exemplary Embodiments—C

A vehicle interior may be configured to with components and systems (e.g. for electrification, network connectivity, etc.) to provide occupants/passengers with comfortable driving experiences; manually-operated components may provide limitations for an occupant/passenger experience; motor/electric-operated components may provide an inoperable failure state. According to an exemplary embodiment, the component may be configured for operation in a manually-operated mode and a motor/electric-operated mode and a failure mode; the component may comprise a component such as a console providing a base and a cover movable between a closed position and an open position to allow access to a storage compartment; the component with cover may comprise a mechanism to provide for manual operation and motor/electric-operation (including a clutch mechanism for use in a failure mode).

According to an exemplary embodiment, the component for a vehicle interior configured to be operated by an operator control may comprise a cover movable relative to a base between a closed position and an open position, a spring-actuated mechanism to move the cover; a motor-actuated mechanism to move the cover. The cover may be moved in a spring-actuated mode under actuation of the spring-actuated mechanism and/or a motor-actuated mode under actuation by the motor-actuated mechanism. The cover may be configured to move on a track system comprising a gear track. The motor-actuated mechanism may comprise a cable-drive system. The spring-actuated mechanism may use spring action to open the cover. The component may comprise a receptacle movable between a retracted position and an extended position. The component may comprise a mechanism actuated by movement of the receptacle.

According to an exemplary embodiment, the component (vehicle interior trim/component) may comprise a base (10) having a storage compartment (H) and a cover (20); the cover (20) may be configured to be movable relative to the base (10) between a first closed position where the storage compartment (H) is covered and a first open position where the storage compartment (H) is exposed in both an electric mode and a manual mode. According to an exemplary embodiment, the component may be configured to avoid failure under operating conditions and to provide a simple structure for practical use in electric/motor operation and manual operation.

TABLE A
REFERENCE SYMBOL LIST

| ELEMENT, PART OR COMPONENT | REFERENCE SYMBOL |
|---|---|
| vehicle | V |
| interior | I |
| instrument panel | IP |
| floor console | FC |
| component | C |
| base | B/10 |
| cover | T/20 |
| movable storage box/receptable | R/20 |
| button | BT |
| button | BX |
| operator control | OC |
| operator control | OCX |
| storage compartment | H |
| storage compartment | S |
| motor-actuated mechanism | MM |
| tension/spring-actuated mechanism | TM |
| latch mechanism | LM |
| track system (cover) | TSC |
| track system (receptacle) | TSR |
| switch/switch mechanism | SW |
| first sliding rail | 11 |
| second sliding rail | 12 |
| first sidewall | 21 |
| second sidewall | 22 |
| third sidewall | 23 |
| teeth | 211 |
| unlocking slot | 221 |
| locking tongue | 231 |
| guide post | 232 |
| slide | 41 |
| clutch lock | 42 |
| cover lock | 43 |
| winder | 44 |
| power-assisted gear set | 45 |
| cable | 46 |
| locking slot | 412 |
| guide post | 411 |
| motor | 49 |
| tension pulley | 47 |
| cable pulley | 48 |
| cable slot structure | 15 |
| lock rod | 421 |
| locking head | 422 |
| first rotating shaft | 423 |
| first tension spring | 424 |
| locking hook | 432 |
| eccentric structure | 433 |
| second rotating shaft | 431 |
| second tension spring | 434 |
| stop rod | 13 |
| fixed shaft | 451 |
| inner gear | 452 |
| outer gear | 453 |
| torsion spring | 454 |
| bearing | 455 |
| damper | 456 |
| rack | 31 |
| first gear | 441 |
| motor | 49 |
| push rod | 32 |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior configured to be operated by an operator control comprising:
(a) a base comprising a compartment;
(b) a cover configured to be movable relative to the base between a closed position and an open position;
(c) a spring-actuated mechanism configured to move the cover; and
(d) a motor-actuated mechanism configured to move the cover;
wherein the cover is configured to be moved in at least one of (a) a spring-actuated mode under actuation of the spring-actuated mechanism and/or (b) a motor-actuated mode under actuation by the motor-actuated mechanism.

2. The component of claim 1 wherein the cover is configured to move on a track system; wherein the track system comprises a gear track.

3. The component of claim 1 wherein the motor-actuated mechanism comprises a cable-drive system.

4. The component of claim 1 wherein the spring-actuated mechanism is configured to use spring action to move the cover from the closed position to the open position.

5. The component of claim 1 further comprising a latch mechanism configured to retain the cover in the closed position relative to the base.

6. The component of claim 5 wherein the latch mechanism comprises a spring-operated mechanism.

7. The component of claim 5 wherein the operator control comprises a button mechanism configured to release the latch mechanism and to move the cover in the spring-actuated mode.

8. The component of claim 1 wherein the cover is configured to move in the spring-actuated mode from the closed position to the open position and in the motor-actuated mode from the open position to the closed position.

9. The component of claim 1 further comprising a receptacle configured to be movable relative to the base between a retracted position within the base and an extended position.

10. The component of claim 9 further comprising a mechanism configured to be actuated by movement of the receptacle from the retracted position toward the extended position.

11. The component of claim 10 wherein the mechanism is configured to release a latch mechanism for movement of the cover toward the open position when the receptacle is moved toward the extended position.

12. The component of claim 10 wherein the mechanism comprises a switch actuated by movement of the receptacle.

13. The component of claim 9 wherein the receptacle is movable relative to the base on a track system.

14. A component for a vehicle interior comprising:
(a) a base comprising a compartment;
(b) a cover configured to be movable relative to the base between a closed position and an open position;
(c) a motor-actuated mechanism configured to move the cover; and
(d) an operator control configured to operate movement of the cover;
wherein the cover is configured to be moved in at least one of (a) a tension-actuated mode and/or (b) a motor-actuated mode under actuation by the motor-actuated mechanism.

15. The component of claim 14 wherein the operator control comprises a button mechanism configured to release a latch mechanism and for movement of the cover in the tension-actuated mode; wherein the latch mechanism comprises a spring-operated mechanism configured to retain the cover in the closed position and to release the cover for movement toward the open position.

16. The component of claim 14 further comprising a tension-actuated mechanism configured to use spring force to move the cover from the open position to the closed position in the tension-actuated mode; wherein the motor-actuated mechanism comprises a cable-drive system operated by a motor to move the cover from the open position to the closed position in the motor-actuated mode.

17. The component of claim 14 wherein the operator control comprises a button configured to initiate movement of the cover in the tension-actuated mode.

18. The component of claim 14 wherein the cover is configured to be moved from the open position to the closed position in a manually-actuated mode.

19. A component for a vehicle interior comprising:
a base comprising a compartment;
a cover configured to be movable relative to the base between a closed position and an open position;
a spring-actuated mechanism configured to move the cover;
a motor-actuated mechanism configured to move the cover;
an operator control configured to operate movement of the cover;
wherein the cover is configured to be moved in at least one of (a) spring-actuated mode under actuation of the spring-actuated mechanism and/or (b) a motor-actuated mode under actuation by the motor-actuated mechanism.

20. The component of claim 19 wherein the operator control is configured to initiate movement of the cover in the motor-actuated mode.
